(19) United States
(12) Patent Application Publication
(10) Pub. No.: US 2010/0311325 A1
(43) Pub. Date: Dec. 9, 2010

(54) SYSTEMS AND METHODS FOR THROUGH-THE-EARTH COMMUNICATIONS

(75) Inventor: David L. Marshall, North Salt Lake City, UT (US)

Correspondence Address: Durham, Jones & Pinegar --;Intellectual Property Law Group, P.O. Box 4050, Salt Lake City, UT, 84110, US

(73) Assignee: MARSHALL RADIO TELEMETRY, INC., North Salt Lake City, UT (US)

(21) Appl. No.: 12/793,651

(22) Filed: Jun. 3, 2010

Related U.S. Application Data
(60) Provisional application No. 61/183,893, filed on Jun. 3, 2009.

(51) Int. Cl. H04B 13/02; H01Q 1/50

(52) U.S. Cl. 455/40; 343/860; 505/211; 505/201

(57) ABSTRACT

Systems and methods for wirelessly sending signals through the earth between transmitting and receiving antennas are disclosed, wherein the communicating antennas are of the types that generate significant far field radiation and may interact substantially through the emission and absorption of electromagnetic radiation in addition to magnetic coupling. Frequencies are typically chosen which may be much higher than those conventionally used for through-the-earth (TTE) communications. In many situations where TTE communication is desired, the electromagnetic coupling and associated magnetic coupling produced and utilized by these certain types of antennas provide greater effective communications ranges when compared with the ranges that are obtainable with antennas interacting predominately by magnetic coupling alone.

### CROSS-REFERENCE TO RELATED APPLICATION

This application claims the benefit of priority under 35 U.S.C. §119(e)(1) to U.S. Provisional Patent Application 61/183,893, filed Jun. 3, 2009, the disclosure of which hereby incorporated herein, in its entirety, by this reference.

### TECHNICAL FIELD

The present invention relates generally to techniques and systems for communicating wirelessly through earth formations and, more specifically, to the use of radiating antennas to wirelessly communication through earth formations.

### BACKGROUND OF RELATED ART

Wireless communication through the earth has been pursued vigorously over the last century. Applications would include the rescue of trapped miners, improved efficiency in mining operations, and improved telemetry from underground facilities, such as boreholes used in underground geological measurements. Yet, the prior art has not reached the point of providing two-way communication through the earth to mines or tunnels of any useful depth.

In the United States the Miner Act of 2006 requires “a post-accident communication system between underground personnel and surface personnel via a wireless two-way medium” by Jun. 15, 2009. As of Apr. 29, 2009, the responsible agency, the Mine Safety and Health Administration (MSHA), had “observed 61 tests or demonstrations of 31 different communications and/or tracking systems at various mine sites” and “had discussions with various vendors regarding 182 different proposals for development of mine communications and tracking systems.”

However, on Jan. 10, 2009 MSHA stated that “fully wireless communications technology is not sufficiently developed at this time, nor is it likely to be technologically feasible by Jun. 15, 2009.”

### SUMMARY

In one aspect, the present invention includes various embodiments of wireless through-the-earth communication systems. Such a system may include a first communication element within a cavity in the earth, as well as a second communication element. The first communication element includes a radiating antenna, as well as a transmitter and/or a receiver that communicates with the radiating antenna. The second communication element, which may be located above ground or at another underground location, also includes an antenna (e.g., a radiating antenna or a magnetic loop antenna), as well as a receiver and/or transmitter, which may be configured to perform at least the opposite function as the transmitter and/or receiver of the first communication element. Without limiting the scope of the present invention, the first communication element may be configured to transmit signals through its radiating antenna, while the second communication element may be configured to receive the signals transmitted by the first communication element. Alternatively, or in addition, the first communication element may be configured to receive signals transmitted by the antenna of the second communication element.

The radiating antenna of the first communication element may be configured to operate at a particular carrier frequency. Above ground, such a radiating antenna would be expected to have a particular resonant length. In some embodiments, the physical length of the radiating antenna of the first communication element is shorter than its corresponding above-ground resonant length.

In addition to a radiating antenna and a transmitter and/or receiver, a first communication element of a wireless through-the-earth communication system of the present invention may also include a tuner, or impedance matching device, which enables tuning of the radiating antenna, including physically shortened embodiments of the radiating antenna, to resonate at the predetermined carrier frequency.

The present invention, in another aspect, also includes methods for establishing a wireless communication station underground. In such a method, a first antenna element of a radiating antenna is oriented in a first direction within an underground cavity, in electrical isolation from the earth formation(s) that surround the underground cavity (e.g., passage, etc.). A second antenna element of the radiating antenna is oriented in a second direction within the underground cavity. In some embodiments, the radiating antenna, which may have a physical length that is reduced relative to a particular physical length that resonates at a particular carrier frequency when the radiating antenna is used above ground, may be tuned to resonate at the same particular carrier frequency underground. Communication is established between the radiating antenna and at least one of a transmitter and a receiver, which enables the underground system to communicate with a remote radio station.

The present invention also includes methods for tuning a radiating antenna used underground. The act of tuning includes positioning a radiating antenna that has a reduced physical length relative to a corresponding, above-ground resonant length for a predetermined carrier frequency, at an underground location. The electric length of the radiating antenna is then adjusted, or tuned, without increasing its physical length beyond the above-ground resonant length to cause the antenna to resonate at the predetermined carrier frequency. In various embodiments, when processes of the present invention are used to tune a radiating antenna underground, the radiating antenna may transmit and/or receive electromagnetic waves having a wide range of frequencies, including, without limitation, frequencies in the range of about 100 kHz to about 1 MHz, frequencies of up to about 1.8 MHz, and even frequencies of up to about 140 MHz.

Other aspects and embodiments, as well as features and advantages of various aspects and embodiments, of the present invention, as well as the meanings of various terms, will become apparent to those of skill in the art through consideration of the ensuing description, the accompanying drawings, and the appended claims.

### BRIEF DESCRIPTION OF THE DRAWINGS

Exemplary embodiments of the invention will become more fully apparent from the following description, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 shows an overall representation of one embodiment of the invention communicating vertically through the earth from a point on the surface to one inside a mine tunnel below it.

FIG. 2 shows a form of wave-guide-like propagation of radiation along a coal seam.

FIG. 3 shows an alternate placement of the aboveground system positioned laterally to a coal seam containing the belowground system.

FIG. 4a shows the placement of two belowground transmitting and receiving systems communicating along a propagation path which is along a coal seam, utilizing horizontally polarized antennas.

FIG. 4b shows the placement of two belowground transmitting and receiving systems communicating along a propagation path which is along a coal seam utilizing vertically polarized, shortened antennas.

FIG. 5 illustrates an embodiment of the invention wherein one or more aboveground systems and/or one or more fixed belowground systems communicate with portable systems carried by mining personnel in the mine.

FIG. 6 shows how the antenna efficiency of a dipole changes as the dipole is shortened. The losses shown are only those in the antenna's elements, not in any matching circuitry or transmission lines.

FIG. 7 shows the changes in the reactive component of a dipole antenna's impedance at various lengths below its resonant length.

FIG. 8 shows the changes in a dipole antenna's radiation resistance at various lengths below its resonant length.

FIG. 9 shows the dependence of radiation efficiency of a shortened dipole antenna on the diameter of the conductors.

FIG. 10 shows the use of tapered conducting elements in a shortened antenna in order to provide lower resistance where the highest currents exist.

FIG. 11a shows different configurations of linear loading as a technique for shortening a resonant, non-folded, center fed dipole antenna.

FIG. 11b shows configurations of resonant, folded, center fed dipole antennas.

FIG. 11c shows different configurations of linear loading as a technique for shortening a resonant, folded, center fed dipole antenna.

FIG. 11d shows examples of off center fed dipole antennas.

FIG. 12 shows a type of linear loading utilizing zigzagging as a technique for shortening a resonant dipole antenna.

FIG. 13 illustrates an alternative technique for shortening a radiating dipole antenna by inductive loading.

FIG. 14 illustrates an alternative technique for shortening a radiating dipole antenna by capacitive loading using capacitive plates.

FIG. 15 illustrates an alternative technique for shortening a radiating dipole antenna by inductive loading using capacitive rods.

FIG. 16 shows a yagi antenna on the surface made of two wire elements which direct radiation from the antenna downwards.

FIG. 17 shows a yagi antenna outside of a coal mine along the protruding coal seam, which is made of wire elements which direct radiation from the antenna along the coal seam.

FIG. 18 shows a yagi antenna completely within a coal mine, with the yagi antenna directing radiation horizontally to other locations in the same coal seam.

FIG. 19 shows an impedance matching device which is attached to the feed point of a dipole antenna.

FIG. 20 shows a flowchart for a method of resonating an underground dipole antenna.

FIG. 21 shows the results of an antenna impedance measurement during the process of tuning an underground, inductively shortened dipole for resonance.

FIG. 22 shows a flowchart for a method of tuning a dipole antenna using a separate antenna tuner.

FIG. 23 shows a perspective view of a short dipole antenna which is inductively loaded by superconducting coils.

FIG. 23a is an enlarged view of the loading coil apparatus of FIG. 23.

FIG. 24 shows an isometric end view of the short dipole antenna of FIG. 23.

### DETAILED DESCRIPTION

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

### DEFINITIONS AND TERMINOLOGY

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

It should be understood that where “earth,” “the earth,” or an “earth formation,” is described as the medium through which communication is desired, is it implied that all other solid media through which radiation passes with high rates of attenuation may be contemplated as well, including earth which contains water or air, either in the interstices between particles, rocks, and other structures of the earth, or within chambers or cavities within the earth. The terms “earth,” “the earth,” and “earth formation,” also include man-made structures such as cement walls, wood beams, or the like through which the radiation must pass to establish communication between an underground radio station and another, remote radio station.

Also, transmission through the earth, in one embodiment, involves transmission through the earth of at least a depth of 30 feet. Other embodiments involve transmission through a depth of at least, for example, 100 and 300 feet. As used herein, the term “depth” refers to a distance through the earth or another such solid medium rather than a specific horizontal, vertical, or intermediary direction.

Forces acting on the electrons in a receiving antenna's conductors which are due to the motion of electrons in the conductors of a transmitting antenna are propagated by several different phenomena, which may be utilized differently in the current invention than in the manner these phenomena are utilized in the prior art. The following definitions may be relied on hereafter to distinguish between these phenomena. Referring to Equations (21.1) on page 21-1 of The Feynman Lectures on Physics, Volume II, Definitive Edition, which is a well reputed, standard textbook on physics:

Let an electron, denoted as e₁⁻, in a conductor of a transmitting antenna, which is set in motion by an alternating voltage driving a current through the transmitting antenna be the “charge which moves” as referred to in the text relating to Eq. (21.1), and let the electric field E and the magnetic field B be fields produced in the vicinity of another electron, e₂⁻, in a conductor of the receiving antenna, due to the motion of e₁⁻.
Then let

C=q/4π∈₀[e_{r′}/r′²+r′/cd(e_{r′}/r′²)/dt]

and let

D=q/4π∈₀c²[d²(e_{r′})/dt²].
Then the electric field, F_{E}, acting on the electron e₂⁻ caused by the motion of electron e₁⁻ is herein defined to be:

F_{E}≡C.
The magnetic field, F_{M}, acting on the same electron is herein defined as

F_{M}≡(e_{r′}×C)/c.
The radiation field, F_{R}, is herein defined to be that which is represented by the following two components acting on the same electron:

F_{R,electric}≡D

and

F_{R,magnetic}≡(e_{r′}×D)/c.

When a radiation field is propagated from a transmitting antenna to a receiving antenna, this interaction may be variously referred to in the art by such terms as radio transmission, radio reception, radio waves, radiation, electromagnetic radiation, electromagnetic interaction, electromagnetic coupling, among others.

When a magnetic field is propagated from a transmitting antenna to a receiving antenna, this interaction is commonly referred to in the art by several terms, including magnetic coupling, Faraday coupling, induction, and magnetic induction.

However, on many occasions in the art the very specific phenomenon of magnetic coupling is loosely or improperly referred to by terms such as radio, radiation and electromagnetic coupling, or by the general umbrella term of electromagnetism, so that its distinction from other electromagnetic phenomena is lost. The importance of the above definitions is due to the fact that a difference between the present invention and the prior art is the present invention's use of electromagnetic coupling, as opposed to magnetic coupling.

The magnitude of the effects in a receiving antenna that are due to an alternating current in the transmitter antenna and are propagated by the resulting magnetic field, as the distance between the two antennas increases, diminish at a much faster rate than do the effects of the associated radiation field. Thus, magnetic coupling is effective over very short ranges, while electromagnetic radiation is effective over much longer ranges. The areas near a transmitter antenna where the magnetic coupling predominates is often referred to as the near field, while the areas further away where the radiation predominates is often referred to as the far field.

Receiving and transmitting antennas which are able to efficiently interact through electromagnetic radiation are also able to interact in a complementary way through magnetic coupling in the near field.

In spite of these beneficial properties, antennas which produce electromagnetic radiation are ignored in the prior art for TTE communication, in favor of those that interact through magnetic coupling.

The terms in the definitions above are kept in italics throughout this document in an effort avoid confusion since they are used in different senses in different quotations.

### Frequencies for Through-the-Earth Communication

The transmission frequency is of prime importance in considerations of what antennas will perform successful through the earth. From the early days of radio through the present day, it has been erroneously accepted either that (1) practical through-the-earth wireless communication is impossible, or that (2) to the extent that through-the-earth wireless communication is possible it requires the use of frequencies below about 30 KHz.

The following references from the art substantiate the above statement:

### Various Statements Regarding Frequencies for Through-the-Earth Communication

U.S. Pat. No. 1,373,612 states in 1919 that, “It is well known in the art that radiated waves do not penetrate earth or water to any appreciable depth.” U.S. Pat. No. 3,740,488 in 1971 states that, “The higher frequencies are attenuated more and accordingly the carrier signal is attenuated after a relatively short distance through the earth.” U.S. Pat. No. 3,900,878 states in 1973 that, “Studies have indicated that the earth is a sufficiently good conductor to inhibit radio wave transmissions above a frequency of several kilohertz.” U.S. Pat. No. 4,652,857 asserts in 1986 that, “An electromagnetic field having a frequency in excess of 3000 Hz may not be coupled through the earth. Such frequencies are so severely attenuated that transmission from a mine or cave is impractical.” U.S. Pat. No. 7,043,204 in 2003 states that, “ . . . higher frequency signals [above 500 KHz] typically travel only 1-10 meters into sedimentary rocks.” U.S. Pat. No. 7,149,472 in 2006 states that, “As previously discussed, signals that travel through the earth for substantial distances must use a carrier frequency of only a few kilohertz.” U.S. Pat. No. 7,149,472 in 2006 also states that, “It is therefore clear that an efficacious wireless underground communication system currently does not exist.”

J. Wallace Joyce, Bureau of Mines, “Electromagnetic Absorption by Rock With Some Experimental Observations”, in 1929-30, as cited in USBM Open File Report 127-85, provides:
In tests through limestone and sandstone overburden over a cave, Joyce found that Low Frequency (LF) signals, such as 500 Hz, gave the best results, while those at 20 to 110 KHz were significantly worse. “This attenuation was so great that Joyce concluded that radio waves could not penetrate the earth enough to be useful for mine rescue operation.

Aarons, J., “Low Frequency Electromagnetic Radiation”, 1959, cited in USBM Open File Report 127-85 explains:
It was found that penetration through the ground was best at low frequencies but because of the long wavelengths involved, the lower frequencies gave poor resolution [in trying to locate the position of objects underground].

Walter E. Pittman, Jr. et al., THROUGH-THE-EARTH ELECTROMAGNETIC TRAPPED MINER LOCATION SYSTEMS. A REVIEW, Tuscaloosa Research Center, USBM Open File Report 127-85, ca. 1981, teaches:
that, in about 1970, the Committee on Mine Rescue and Survival Techniques “ . . . recognized that low frequencies [500-1,000 Hz] would have to be used for sufficient earth penetration; but that presented another problem, that of a low rate of data transmission.” (Page 11).
that numerous studies of background noise and propagation at low frequencies were conducted in the 1970's, e.g. from 20 Hz to 20 KHz. “ . . . from experimental results and theoretical calculations an optimum systems was proposed [by Arthur D. Little, Inc.]. This system transmitted . . . at 870 Hz.” (Page 13).
that, around 1974, research by the National Bureau of Standards found that for mines deeper than 300 m “low frequencies (100-500 Hz) would have to be used to achieve adequate penetration.” Shallower depths could “allow the use of frequencies up to 5 Khz or even higher.” (Page 15).

“USBM Grant No. G133023, THRU-THE-EARTH ELECTROMAGNETICS WORKSHOP, RICHARD G. GEYER, FINAL REPORT”, SUMMARY OF UPLINK AND DOWNLINK COMMUNICATIONS WORKING GROUP, Robert L. Lagace, et al., Arthur D. Little Inc.”, 1973, teaches:
To date the combination of overburden transmission loss and available surface noise data have identified the frequency band below 5 KHz as the most favorable for practical narrow band uplink data systems intended for coal mines with over burden depths of up to 1,000 feet . . . which should cover most coal mine situations. (Page 183).
The deep hardrock mine situation is a vastly more difficult one [than that of nominal coal mine conditions] . . . requiring frequencies down to 500 Hz and possibly 100 Hz and even below . . . (Page 190).

In “Control and Monitoring via Medium-Frequency Techniques and Existing Mine Conductors”, Harry Dobroski, Jr. and Larry G. Stolarczyk explain, at page 1:
Over the last several years, numerous attempts have been made to develop radio systems useful in underground environments such as mines . . . . Unfortunately, underground radio propagation is extremely difficult, and conventional approaches have not been successful. The problem clearly calls for unconventional approaches [i.e., the approach of using existing wires and other conductors inside the mine].

In “Underground Coal Mine Communications and Tracking Status”, Roy S. Nutter, Jr., 2007, teach:
Frequencies that penetrate the earth well and might be used for through-the-earth transmission between surface and underground are very low in frequency (typically a few Hertz (ELF) to 30 KHz (VLF).) . . .
Low frequencies ‘LF’ (30 KHz-300 KHz) and Medium Frequencies ‘MF’ (300 KHz to 3 MHz) have been used at times. Trolley phones used in mines even today use 30 KHz to 100 KHz for communications along tracks and other metal conductors in the entryways. These mostly work but need metallic infrastructure as conductors to operate at any distance. Even higher MF frequencies do not penetrate well but can propagate in open entries with metallic structures.

The last two references refer to Medium Frequency (300-3,000 KHz) signals being propagated along incidental conductors within a mine, such as tracks, power lines and coal haulage beltways. In the field of coal mine communications the term “MF System” (for example, see Postaccident Mine Communications and Tracking Systems, Novak, Snyder, and Kohler, IEEE Transactions on Industry application, March/April 2010) has almost become synonymous with this kind of system. This is not confusing because the prior art teaches against using such frequencies for communication from within a mine to the surface via TIE propagation.

In summary, the prior art teaches the use frequencies much lower than 30 KHz, and typically below 5 KHz, for TTE communication.

### Antennas for Through-the-Earth Communication

The utilization of such low frequencies limits the choice of the kinds of antennas that may be used. In fact, at these low frequencies the wavelengths are so long that it is thought, in the prior art, that there is only one kind of antenna that is small enough to be used in the restricted spaces available underground, namely, the magnetic loop.

The prior art teaches use of magnetic loops solely for through-the-earth communications. The term magnetic loop, in the sense that the term is used in the pertinent art and in the context of through-the-earth communications and as used hereafter in the present document, means an antenna that is comprised of one or more loops of wire with dimensions much smaller than the wavelength of the frequency being used, and which has a core primarily of either air or of certain ferromagnetic materials. Synonymous terms used in the art include loop, transmitter loop, receiver loop, loop antenna, ferrite loop, ferrite rod, electromagnetic field transducer, small loop antenna, and magnetic dipole. Such small magnetic loop antennas are different from large loop antennas encountered in others contexts, such as those of aboveground communications, which are also commonly referred to just as loop antennas. The fundamental difference between the small loops antennas that are used in the present art for TTE communications, and the large loop antennas which are used in other contexts, is that small loop antennas interact primarily through the medium of magnetic coupling over only relatively short distances, while large loop antennas, (and virtually every other kind of antenna), interact through both the medium of magnetic coupling over short distances and also through the medium of electromagnetic radiation over longer distances.

The distinction between large loop antennas, which are used in certain embodiments of the present invention, and the small loop antennas of the prior art is very clear in the literature of radio engineering. For example, a widely read text says: “A ‘small’ loop can be considered to be simply a rather large coil, and the current distribution in such a loop is the same as in a coil . . . . To meet this condition the total length of the conductor in the loop must not exceed about 0.1λ.” (see ARRL Antenna Book, 20^{th} edition p. 5-1). Also, “A ‘large’ loop is one in which the current is not the same either in amplitude or phase in every part of the loop. This change in current distribution gives rise to entirely different properties compared with a small loop.” (Ibid.) Thus, to be considered as an effective radiator, a loop antenna should have a loop circumference greater than 1/10 of a wavelength. The importance of the distinction as far as the present invention is concerned is profound, as stated here: “ . . . and [radiation] efficiency [of any loop antenna] drops off rapidly below ⅛λ.” (Ibid. p. 5-13) Many other textbooks can likewise be cited.

Within the art, a certain kind of loop antenna is sometimes used which at first may appear to be like a normal, full-sized, radiating electric dipole. It is called a long wire, a grounded long wire, or horizontal long wire antenna, or HWA. In the art these antennas are grounded at the ends and produce a return current through the earth. Therefore, they behave as magnetic loop antennas. In spite of the use of the word “long,” the lengths of such antennas, when used in conjunction with the low frequencies always used in the prior art, are actually extremely short in comparison to the associated wavelengths, and are therefore not effective radiators of electromagnetic radiation. For example, at 1 KHz a half wavelength is 150,000 meters. Thus the term “long wire” used in the art is somewhat misleading in that a wire having good radiation efficiency at that frequency would be far longer still, and according to the common usage in the field of radio engineering of the term “long wire antenna” would refer to an antenna that would be a multiple of 150,000 meters.

Magnetic loop antennas create strong magnetic fields within the loop, but outside the loop the magnetic fields created by the loop are weak, because the currents in all parts of the loop are always almost completely in phase, and the current in any part of the loop is balanced by an exactly opposite current somewhere else on the loop, so that the magnetic fields outside the loop at a distance from the two parts are almost completely cancelled by destructive interference. Likewise, in the cases of the HWA, equal and opposite currents flow through antenna wires and through the return ground path, largely canceling out each other's radiation. In the same way, the electric fields generated by small loop antennas are almost completely confined to the space within the loop. Therefore, the radiation resulting from magnetic loop antennas is weak at a distance because of the near cancellation of contributions from opposite currents around the loop.

Efficiently radiating conductors are on the order of a half wavelength long electrically, and are ordinarily called dipoles. However, as with HWA antennas, the antennas sometimes referred to in the art of underground communications as dipoles, are actually electrically short, essentially non-radiating antennas, which are used for their magnetic coupling properties. The same is true for another electrically short type of antenna related to the dipole that is occasionally referred to in the art as a whip, or as a “whip-type dipole.” Such kinds of antennas which are used as non-radiating, magnetic couplers in the art of underground communications, are sometimes confusingly referred to as electric dipoles, electric radiators, or electric antennas, even though these same terms are virtually always used in other arts to denote radiating antennas. In some underground research experiments, such antennas, referred to as “electric receiving sensors” or “short dipoles,” are used as receiving sensors in earth propagation measurements (see USBM Grant No. G133023 Workshop Final Report, p. 15, p. 23.) In spite of this kind of misused terminology, the short antennas used at such extremely low frequencies are being used so that said antennas interact principally through magnetic induction, and are used to detect magnetic fields, rather than electromagnetic radiation, as an examination of the actual experiments in the literature will confirm.

Thus, the art has its own unique and specialized terminology used in connection with magnetic loop antennas. The following references substantiate the above assertions relative to the prior art with respect to the universal use of magnetic loop antennas for through-the-earth communications and locating.

U.S. Pat. No. 3,967,201 states in 1964 that, “It can be shown that a magnetic dipole is considerably more efficient for communication through a lossy medium [such as earth] than an equivalent electric dipole.” U.S. Pat. No. 3,900,878 in 1982 states that “At frequencies below this range [i.e. below several kilohertz], transmission occurs predominantly through the magnetic field rather than actual electromagnetic radiation.” US Patent 2008/0009242 A1 in 2008 states:
One difficulty to be considered in communicating data underground is the relatively high attenuation encountered by an electromagnetic signal when transmitted through a medium of wet sub-soil, clay and rock . . . . To overcome the problem of high attenuation, magnetic coupled antennas are used . . . . In the underground environment, using electrically insulated magnetically coupled antennas provides various advantages over the alternative of electrically coupled antennas.

Walter E. Pittman, Jr. et al., THROUGH-THE-EARTH ELECTROMAGNETIC TRAPPED MINER LOCATION SYSTEMS. A REVIEW, Tuscaloosa Research Center, USBM Open File Report 127-85, ca. 1981:
Two antenna types, the grounded long wire and the loop, were recognized [by The Committee on Mine Rescue and Survival Techniques around 1970] as potentially effective in mine usage at low frequencies [500-1,000 Hz]. (Page 11)
   From experimental results and theoretical calculations an optimum system was proposed by Arthur D. Little, Inc. in 1973, which transmitted from “a 100 turn, 15 AWG wire [loop] antenna, 1 m in radius and was picked up by a 29 turn 0.4 m radius [loop] antenna.”

“USBM Grant No. G133023, THRU-THE-EARTH ELECTROMAGNETICS WORKSHOP, RICHARD G. GEYER, FINAL REPORT”, SUMMARY OF UPLINK AND DOWNLINK COMMUNICATIONS WORKING GROUP, Robert L. Lagace, et al., Arthur D. Little Inc.”, 1973:
Uplink communications [from inside a mine upwards] to date have primarily utilized loop source antennas of vertically oriented magnetic moment . . . . Such loops have been preferred over long wire antennas for in-mine installations because of their lower input resistance, fixed impedance characteristics over time, and convenience of installation . . . (Page 184).
Downlink communications [from the surface downwards] to date have primarily utilized grounded, horizontal long wire source antennas . . . . In the mine the wire's magnetic field is primarily horizontal . . . (Page 191).

“TRANSMIT ANTENNAS FOR PORTABLE VLF TO MF WIRELESS MINE COMMUNICATIONS”, USBM CONTRACT FINAL REPORT (H0346045), Robert L. Lagace, et al, Arthur D. Little Inc.”, 1977:
The size of [compact, portable transmit antennas] relative to wavelength classifies them as electrically small antennas which, by their very nature, are poor radiators. No major breakthroughs have occurred, or are likely to occur, to change this fact . . . . As a result, the choice of a specific antenna should not be based on its radiation efficiency . . . . Thus, it is concluded that conventional air-core bandolier loop antennas, and perhaps small ferrite-loaded loop antennas will be the most suitable and reasonable choices for roving miner portable radio applications at frequencies below about 1 MHz. (Page 3).
   The radiation efficiency of a typical loop, 0.5 meter in diameter with 10 turns, is cited as having a “negligible antenna efficiency of only 2×10⁻⁷%.” (Page 33).
. . . the efficiency of even optimally loaded 2 meter whips falls off rapidly at the low end of the HF band when the whip becomes less than about 0.05λ. (Page 41).
Thus the transmit antenna size constraint for portable mine wireless voice communication applications, together with the system bandwidth required, make a goal of high radiation efficiency not only unattainable, but also undesirable for the VLF, LF, and even MF, radio bands from 10 KHz to 1000 MHz. (Page 45).
Therefore, it becomes apparent that based on this measure of performance for antennas in a conduction medium, the advantage enjoyed by the dipole over the loop in free space does not apply in a conducting medium . . . [and] the loop is clearly seen to be the most favorable antenna. (Page 47).
. . . conventional whip antennas are incompatible with the MF band wireless radio application. (Page 51)
Conventional air-core loop antennas represent one of the most suitable and effective choices for the MF mine wireless roving miner application. Thus it is not surprising that the South Africans and the British have adopted the use of such antennas for rescue type, portable MF band communications in mining and firefighting respectively. (Page 54).
In many applications, loops loaded with magnetic core materials offer equal or improved performance in a considerably reduced cross-sectional area and volume over that of an air-core loop. (Page 63).
   “Horizontal long wire antennas strung along the roof of a mine tunnel and grounded to the rock above the coals seam by roof bolts” are discussed. With the described grounding, and at the given frequency of 300 Khz and the lengths of 10 to 100 meters, these antennas are magnetic, hence in this paper the “effective magnetic moments of the long wire and its return path in the roof” are calculated. (Pages 78-80).

“Quasi-Static Magnetic-Field Technique for Determining Position and Orientation,” Raab et al., ca. 1981, cited by USBM Open File Report 127-85:
The [ELF] field produced at the surface by a buried transmitter was essentially a pure quasi-static magnetic dipole field and that the associated electric field was negligible . . . . Conversely, the amplitude of the magnetic field falls off very rapidly with distance.

“Medium frequency body loop antenna for use underground,” B. A. Austin, IEE Colloquium on Electrically Small Antennas, Oct. 23, 1990:
The candidate antenna-types can be considered to be either electric or magnetic dipoles: i.e. short rods or whips, or small loops. The final choice between them is influenced predominantly by practical considerations. The very confined working environment in narrow tunnels and passages makes the whip antenna both an impractical and a dangerous option.
. . . another significant factor in favour of the loop or magnetic dipole is that when both antennas are placed within an insulating cavity (a tunnel, say) of radius R, within a lossy, dielectric medium (rock), the loop is the more efficient radiator [compared to an electric dipole of about the same small size].

“Underground Wireless Communications using Magnetic Induction,” Zhi Sun and Ian F. Akyildiz, IEEE Communications Society, ICC 2009 proceedings:
“The well established wireless communication techniques using electromagnetic (EM) waves do not work well in this [underground] environment due to three problems: high path loss, dynamic channel condition and large antenna size.”
. . . MI [magnetic induction] is generally unfavorable for terrestrial wireless communication since magnetic field strength falls off much faster than the EM [electromagnetic] waves.

### Antennas Prescribed by Patent Disclosures for TTE Communications:

| Patent | Year | Antennas Described |
|---|---|---|
| U.S. Pat. No. 2,992,325 | 1959 | Horizontal long wire antenna, |
| | | grounded with metal balls on |
| | | the ends; Also uses loops of wires |
| U.S. Pat. No. 3,967,201 | 1964 | “Magnetic dipole antennas” |
| | | constructed of “solenoidal |
| | | windings wound around a |
| | | ferromagnetic core material”; |
| | | transmitting at “audio |
| | | frequencies” |
| U.S. Pat. No. 3,740,488 | 1971 | Air or ferrite core loop antennas; |
| | | e.g. 800 turns over 0.69 square |
| | | meters (for receiver); a long |
| | | insulated wire with the ends grounded |
| | | to the earth (for transmitter on |
| | | earth surface). |
| U.S. Pat. No. 3,900,878 | 1973 | Magnetic loop antennas |
| U.S. Pat. No. 4,163,977 | 1977 | Two equal loops for receiving |
| | | and a transmitter loop generating |
| | | a magnetic field |
| U.S. Pat. No. 3,828,867 | 1972 | Receiving loops, also referred |
| | | to as sensors; |
| | | [i.e. magnetic sensors] |
| U.S. Pat. No. 4,710,708 | 1982 | Air core and ferromagnetic core |
| | | loops which produce a magnetic |
| | | field pattern |
| U.S. Pat. No. 6,160,492 | 1998 | Windings wrapped around a |
| | | magnetically permeable annular |
| | | core |
| U.S. Pat. No. 4,652,857 | 1986 | Faraday coupling between the |
| | | transmitter antenna which |
| | | produces magnetic flux and |
| | | induces current in the receiver |
| | | antenna |
| U.S. Pat. No. 6,370,396 | 2000 | Magnetic coupling between loop |
| | | antennas |
| U.S. Pat. No. 7,043,204 | 2006 | Small loop antennas producing |
| B2 | | magnetic fields, including |
| | | “flux locked loops.” |
| U.S. Pat. No. 7,050,831 | 2002 | Loop antennas operable to receive |
| | | signals by Faraday coupling. |
| U.S. Ser. No. 10/043,901 | 2002 | Magnetic loop antennas |
| US 2008/0009242 Al | 2008 | Magnetically coupled loop antennas |

### Antennas Used in Research Experiments Involving TTE Communications:

| Researcher | Year | Equipment Tested | Antenna |
|---|---|---|---|
| Westinghouse Special Systems | 1970- | Developed by | On the surface: |
| Division; Contract H0220073, | 1971 | Westinghouse Special | Long Horizontal |
| cited in cited in USBM Open File | | Systems Division | Wire. |
| Report 127-85, p. 16. | | 1971-2. | |
| Westinghose; Second Phase | 1972- | Prototype TTE | In the mine: |
| Contracts, cited in USBM Open | 1973 | Location and | horizontal loop, and |
| File Report 127-85, p. 17. | | Communication | deployable long |
| | | System | wire; Surface: |
| | | | Handheld loop and |
| | | | antenna loop towed |
| | | | beneath a |
| | | | helicopter |
| Colorado Schools of Mines, | 1974 | Pulse Transmitter | Vertical axis loops |
| Bureau of Mines contract | | developed for the | and horizontal wire |
| No. H0101691, cited in USBM Open | | contract | antenna |
| File Report 127-85, p. 23. | | | |
| Westinghouse, US Bureau of | 1978 | Made by General | Receiving: 15 inch |
| Mines Contract No. J0166060; | | Instrument Corp., | loop, 500 turns, |
| Reported in “RELIABILITY AND | | under contract to | Transmitting: “#12 |
| EFFECTIVENESS ANALYSIS | | Bureau of Mines, cited | wire loped around |
| OF THE USBM | | in USBM Open File | one or two coal |
| ELECTROMAGNETIC | | Report 127-85, p. 24. | pillars.” 90 ft. and |
| LOCATION SYSTEM FOR | | | 400 ft. This is |
| COAL MINES”. | | | .0013 wavelength |
| | | | at the maximum |
| | | | frequency used, |
| | | | 3,030 Hz. |
| F. A. Raab et al., cited in USBM | 1979 | NA | Three axis |
| Open File Report 127-85, p. 28. | | | magnetic dipole |
| | | | and three axis |
| | | | magnetic sensor |
| USBM Contract No. 243-244, | 1979 | Polhemus Navigation | Three sets of three |
| cited in USBM Open File Report | | Sciences | mutually |
| 127-85, p. 29. | | | orthogonal wire |
| | | | loop elements |
| US Bureau of Mines, | 1977 | Wireless prototype | Receiving Antenna: |
| Collins/Rockwell Contract No. | | radio developed by | Square shielded |
| H00366028; Reported in | | Collins Telecommunications; | loop (.73 sq. meters) |
| “Propagation of EM Signals in | | also radios from | Transmitting antenna: |
| Underground Mines”. | | ECAM of South Africa. | 4 to 7 turns, |
| | | | 2 m diameter loop. |

| Commercial System | Antennas Utilized |
|---|---|
| Mine Site Technologies | Magnetic loop antenna |
| Transtek, Inc. | Magnetic loop antenna |
| Kutta Consulting | Magnetic loop antenna |
| Geosteering | Magnetic loop antenna |

Source:
Mine Emergency Communications Partnership, Phase I, In-Mine Testing, National Institute for Occupational Health, 2006).

### Statements in Reference to Communication Along Coal Seam Strata

Similar conclusions have been reached in regards to the transmission of wireless signals along coal seams. T. L. Wadley, of South Africa, in 1949, as cited in USBM Open File Report 127-85:
Communication . . . through rock were possible if low radio frequencies were utilized. The South Africans achieved a useful range . . . at 300 KHz.” Loop antennas were used then, and later at 903 KHz.

In “MEDIUM-FREQUENCY PROPAGATION IN COAL MINES”, H. Kenneth Sacks, Pittsburgh Mining and Safety Research Center, U.S. Bureau of Mines, tests were conducted using frequencies between 60 and 2,000 KHz using magnetic loop antennas with a “effective turns area” of 1 square meter. In conductor free areas the propagation depends on coal seam properties and maximum ranges were between 300 and 900 KHz.

“TRANSMIT ANTENNAS FOR PORTABLE VLF TO MF WIRELESS MINE COMMUNICATIONS”, USBM CONTRACT FINAL REPORT (H0346045), Robert L. Lagace, et al, Arthur D. Little Inc.”, 1977:
Thus, the VLF-MF mine wireless communication problem is one of optimizing the near field and induction field coupling between two loosely coupled portable electromagnetic field transducers (antennas) . . . (Page 3).

“COUPLING OF THE COAL-SEAM MODE TO A CABLE IN A TUNNEL AT MEDIUM FREQUENCIES—SUPPLEMENT TO FINAL REPORT”, USBM CONTRACT H0346045, Robert L. Lagace, a.g. E. M. Emslie, Aurthur D. Little Inc.”, 1980 [Formulas predicting the degree of coupling of small magnetic loops to a cable are derived]:
The foregoing suggests that horizontally oriented loop antenna may provide an efficient communication system in areas where conductors such as power lines, trolley lines, and rails are present. (Page 40).

### Statements in Patent Disclosures Referring to Propagation Along Coal Seam Strata

| Patent | Year | Frequency | Antenna |
|---|---|---|---|
| U.S. Pat. No. 4577153, | 1985, | 300 to 800 KHz. | “Tuned-loop antenna” which excites |
| US Re 32563 | 1986 | | the “azimuthal magnetic field |
| | | | component” of a coal seam. |
| U.S. Ser. No. 11/771,140 | 2007 | 100 Hz to 100 KHz | “Coil or loop” antennas which are |
| | | | “magnetically coupled” |

In summary, the prior art teaches exclusively the use magnetic loop antennas for TTE communication.

The types of antennas that do radiate effectively, or radiating antennas, may be referred to in the art synonymously as electric antennas, as opposed to poorly radiating magnetic antennas. As used herein, the term radiating antenna also refers to antennas that are not magnetic loop antennas. This class includes the common dipole antenna, otherwise known as the electric dipole, and many variations of it. The class of radiating, or electric antennas includes a variety of antennas, including, without limitation, non-looped and looped antennas, with a maximum span of at least one tenth of a wavelength of an intended carrier frequency, at least one hundredth of a wavelength of the intended carrier frequency, at least three hundredths of a wavelength of the intended carrier frequency, and even at least one thousandth of the wavelength of the intended carrier frequency. Nonlimiting examples of certain basic types of antennas that fall within this class include but are not limited to the folded dipole, inverted V dipole, dipoles with parasitic elements, dipole arrays with multiple driven elements, moxon dipole antennas, large loop antennas, quad and delta antennas, long wire antennas, rhombic and beverage antennas, monopole antennas, whip antennas, bowtie antennas, Goubau antennas, normal mode helical dipole antennas, L antennas, off-center-fed dipole antennas and many others. Monopole and whip antennas are actually technically dipoles, wherein the first of the two fundamental polar elements of the dipole is either simply very short, or is grounded, or is connected to some other kind of counterpoise element, which said ground connection or counterpoise elements comprises part of the said first element of the dipole.

The attribute that these radiating antennas or electric antennas have in common with each other, but not in common with the magnetic loop, is that they have currents of amplitudes or phases that differ over electrical distances that are at least some substantial fraction of a wavelength. These said out of phase currents at different locations complement and reinforce each other at points that are distant from the antenna by design, in order to generate strong magnetic fields and electromagnetic radiation. That the currents of such an antenna can be made to flow with such different phases over distances is due to the existence of electric fields between conductive elements of opposite electric polarity within and external to the span of said antenna elements.

Hence, hereinafter when the term dipole is used, it may be thought to represent the general class of all such electric antennas including those enumerated above, and to expressly exclude magnetic dipoles, and this is according to the common terminology of the field of radio engineering. That this common usage of the term dipole exists is due to the fact that essentially all of the abovementioned electric antennas can be made from the most basic of all antennas, the common dipole, by bending, stretching, cutting, or reshaping the two basic dipole elements, or by connecting additional conductors, such as metal plates, to said two basic elements.

In addition, large loop antennas and folded antennas, even though they have at least one loop element, are included in the class of electric antennas because the said loop elements are large enough to behave electrically as dipoles and to produce the phase differences, and the associated electric fields, mentioned above.

Electric antennas that are greatly shortened, even to the size of a typical magnetic loop, are still classified as electric antennas, since the loading means by which they are physically shortened, such as the insertion of series inductors, introduce significantly long electrical delays within the conduction paths of the antenna elements, so said antennas are electrically long and radiate electromagnetically, even though physically short.

Whenever transmission or radiation is referred to in regards to antennas, it is to be understood that the reciprocal actions of reception, receiving and electromagnetic absorption are implied as well according to the law of reciprocity.

The terms regarding antennas are often kept in italics in this document in an effort avoid confusion since they are used in many different senses in the literature.

Utilizing the disclosed systems and methods, experiments by the inventor have shown that frequencies from about 450 MHz down to about 270 KHz, when utilized in conjunction with radiating antennas, effectively propagate through the earth. The said experiments have shown that at lower frequencies within this range signals are generally more effective at penetrating the earth than at higher ones, and suggest that as the frequency used is lowered below said 270 KHz they will continue to exhibit increasingly more effective propagation through the earth. In the said experiments it has also been shown that signals can clearly propagate through the earth via electromagnetic radiation, and not solely or primarily through magnetic coupling. Such signals have been transmitted and received experimentally using full sized dipole antennas over distances of multiple wave lengths through the earth, in which cases the magnetic field component is extremely weak.

These experiments demonstrated that effective through-the-earth communication through the use of new, radiating antenna technology can be achieved, thus presenting many opportunities for practical use. Various embodiments of systems and methods that include radiating antennas, including but not limited to those disclosed herein, may be employed to overcome the restrictions imposed by conventional practices by augmenting magnetic coupling with that of electromagnetic radiation, which has different and often advantageous properties during propagation through the earth.

An electric antenna used underground typically will be much larger than the magnetic antennas currently used. Thus, there must be a compromise between the practical size of said electric antenna and the frequency which is used. Thus, embodiments of the disclosed system enable using the lowest frequency for which it is still practical to effectively build and use a radiating antenna. Both the parameters of antenna size (bigger is better, but less practical) and frequency (lower is better, but necessitates yet bigger antennas) may be considered simultaneously in order to obtain reasonable effectiveness.

The lowest frequency for which it is possible to effectively use a radiating antenna will depend on the application and environment where it is to be used. Depending on the circumstances, it may be practical to construct and utilize a radiating antenna at arbitrarily low frequencies, including in the Low Frequency (LF) band or lower. An underground mining environment with long, accessible tunnels may allow for relatively long antennas to be stretched along said tunnels. It is probably practical in many underground situations to use Medium Frequencies (MF) with radiating antennas. As a general rule, it appears so far that frequencies found in the MF band will be particularly useful underground, as MF band frequencies provide a good compromise between antenna sizes and TTE attenuation rates. High Frequencies (HF) may also be useful in many TTE applications and will allow for more modestly sized radiating antennas.

### The Size of Radiating Antennas Underground

The inventor has discovered that when a typical radiating antenna (for example, a half wave dipole) that is resonant aboveground, is placed underground in a cavity, its input impedance changes significantly. This change in input impedance has been discovered to occur generally in such a way as to make said antenna resonant at a lower frequency. This important discovery opens up a way, unreported in the prior art, toward making reasonably sized, radiating antennas work underground. The result of this phenomenon is that the antenna's dimensions may actually be shortened in order to make the antenna resonant underground.

The effect of the surrounding earthen walls of the cavity on antenna resonance can be approximated by the following formula:

K=1−0.7/D²

### Where:

K is the factor by which lengths of dipole elements in a long cavity are reduced from their freespace values.
D is the mean diameter of the cavity in meters, where D>2.
   Even so, electrical resonance, which is critical for success with radiating antennas, may be very difficult to achieve. This is especially true when the elements of such an antenna are shortened further below the dimensions required for resonance in the underground environment. Due to the unpredictable electromagnetic characteristics of an underground environment, the proper dimensions and other attributes of such a resonant, underground antenna cannot yet be predicted accurately by formulas. Obtaining resonance in such antennas requires special care and certain techniques.

Ignorance of the abovementioned differences between above and belowground resonance probably accounts for negative test results of people that may have attempted higher frequency TTE propagation in the past. This is because of the fact that if said differences are not carefully compensated for, an antenna's performance underground will be severely impaired. For example, someone who was testing HF or MF propagation underground with a portable, military HF transceiver with an antenna which is short and reasonably effective aboveground, and who didn't know about and compensate for the abovementioned change in antenna impedance underground, will experience failure to find any TTE propagation. Said person may have unknowingly attributed the resulting failure to negative properties of said antenna and frequency. Such a person may have concluded that through-the-earth propagation at MF and HF is not even possible.

As important as the process of resonating an underground radiating antenna is, it is merely part of a larger process for maximizing the power transferred between the antenna elements and the transmitter (or reciprocally, the receiver) being used with the antenna. This larger process of tuning the antenna system may also be referred to in the art as “tuning the antenna,” “matching the antenna to the transmitter,” “resonating the antenna system,” “impedance matching,” and other like terms. The elements of said larger process of tuning the antenna system may include the physical processes of altering or adjusting the dimensions and properties of elements of the antenna itself, which may include wires, coils, plates, and other conductors and dielectric materials, and also to processes involving adjusting elements external to the antenna proper, such as those comprising the insertion and adjustment of impedance matching devices or transmission lines, or other elements which are intermediary in the connection between said transmitter and the antenna proper, or may even reside within the transmitter itself.

It is to be understood that while no particular combination of antenna tuning acts is considered to be essential to the scope of the present invention, none of the parts of this process of tuning the antenna system can be considered in isolation from the others, since each of them effects the overall characteristics of the entire antenna system, including the properties of resonance, impedance, power transfer and efficiency. It is also understood in the art that generally all of the components of the entire antenna system, whether mechanically part of the antenna proper or not, present an influence on those properties. In the terminology of the art, such components may be alternatively referred to as parts of the antenna, or as parts of an impedance matching device, a matching circuit, an antenna tuner, or other like devices. This is especially true of components at the feed point of the antenna, such as transformers or transmission line stubs, which may be said to be a part of the antenna, or alternately as part of an impedance matching device, and not a part of the antenna. The transmission line itself, even though its primary purpose may be to connect the transmitter to the antenna, may have important effects on the overall impedance match. Therefore to avoid confusion, hereinafter the terms “connection device,” “matching device,” and “impedance matching device” are to be understood simply refer to any or all of those elements of the entire antenna system which are not the elements described as part of the antenna itself.

It is to be understood that the presence of wires, coils, transformers and other magnetic or inductive components do not alone qualify an antenna to be considered to be a magnetic antenna. Such components are commonly used for impedance matching and conduction of currents within non-magnetic, radiating antennas such as dipoles, and do not constitute the principal sources of the overall fields generated by said radiating antennas.

It is assumed by many people that shortened radiating antennas are intrinsically less efficient because they have a smaller “aperture” or “capture area” relative to the wavelength. When considered in the far field, this assumption is not correct. For example, over long distances a dipole which is 0.1% of its resonant length will have equal transmitting and receiving efficiency compared to one of full-size, if the losses in its elements and impedance matching system can be sufficiently minimized. On the other hand, in the near field the situation is much more complex, especially underground. The interactions between the different elements of radiating antennas of given lengths depend on geometric distances and orientations, timings and phases over distances, and on the varying conductive and dielectric properties of the intervening earth medium within the near field. However, it will usually be found that the process of aligning the current conducting elements comprising the receiving and transmitting antennas so that they are mostly parallel and side by side will produce a preferred configuration.

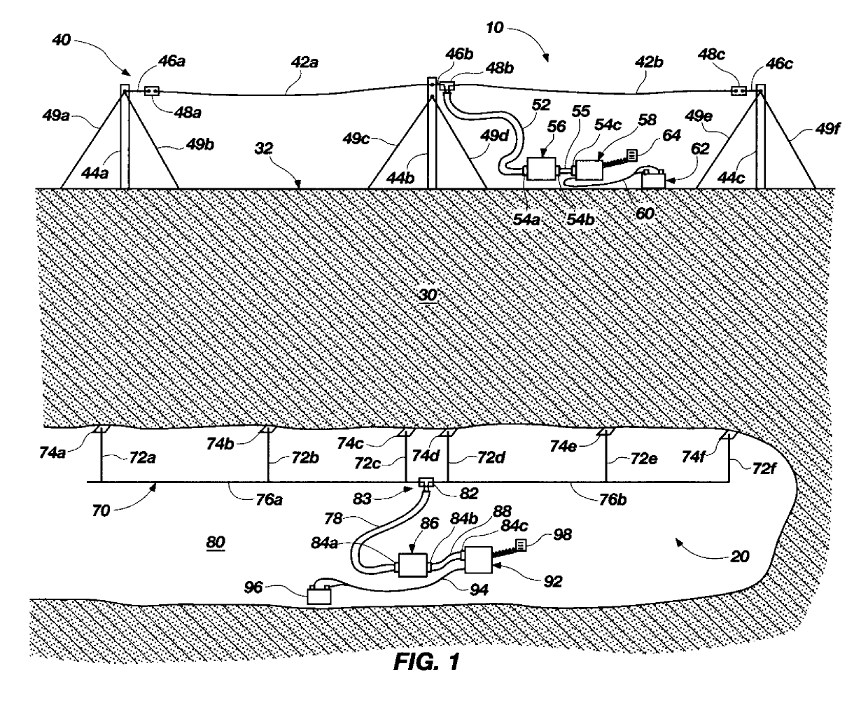

FIG. 1 shows an overall representation of one specific, non-limiting embodiment of the invention. Aboveground system 10 may include a radio receiving and transmitting apparatus which communicates with belowground system 20, which may also include a radio receiving and transmitting apparatus, through the medium of the earth 30. Aboveground system 10 is above the surface of the earth 32. Aboveground system 10 includes an aboveground antenna 40, which may be an type of antenna, including a radiating antenna or a magnetic loop antenna. In the depicted embodiment, aboveground antenna 40 is a center-fed half wave dipole antenna constructed in the ordinary manner for such antennas. The aboveground antenna 40 may be comprised of two conducting elements 42a and 42b which are wires connected to antenna support rods 44a, 44b, and 44c through insulating strain relievers 48a, 48b, and 48c and through ropes 46a, 46b, and 46c. Antenna support rods 44a, 44b, and 44c may be held securely by guy ropes 49a, 49b, 49c, 49d, 49e, 49f, and by other guy ropes not shown. The guy ropes may be anchored securely to the ground by steel rods, not shown. Conducting elements 42a and 42b may be made of 10AWG stranded copper wire which may be insulated from the air by plastic sheaths along their entire lengths and at their ends by silicon sealant. Antenna support rods 44a, 44b, and 44c may be 10 foot pieces of two inch PVC irrigation pipe. Conducting elements 42a and 42b may be soldered separately to the inner and outer conductors of coaxial cable 52 at insulating strain reliever 48b. Coaxial cable 52 may be of type RG-213/U and may be connected by RF connector 54a to the RF output terminal of antenna impedance matching device 56. RF connector 54a may be of the PL-259 type required by antenna impedance matching device 56, which may be the MFJ-986 Differential T Antenna Tuner manufactured by MFJ Enterprises. The RF input to antenna impedance matching device 56 may be connected by coaxial cable 55, which may be one meter of type RG-213/U with PL-259 type connectors on each end such as item CXP213C3 manufactured by Cable Xperts, to the RF output connector of transceiver 58, which may be the IC-7000 manufactured by ICOM Incorporated. Transceiver 58 may be fed power by its power cable 60 which is connected to power supply 62, which may be comprised of one or more 12 volt deep cycle AGM lead acid batteries together capable of supplying at least 150 AH of energy.

Transceiver 58 may be connected to a microphone 64, through which an aboveground operator speaks. During operation of aboveground system 10, the operator's voice may cause the transceiver 58 to modulate a carrier signal in single sideband (SSB) mode and to amplify said signal to produce an RF alternating voltage of an impedance of 50 ohms at its output which may be transmitted along coaxial cable 55 to the input of antenna impedance matching device 56, where its impedance may be converted at its output to the exact impedance presented by coaxial cable 52 at that point. From there the RF signal may be conducted by coaxial cable 52 to the center of aboveground antenna 40, whence it may travel to the ends of conducting elements 42a and 42b. The effect of the currents created by the RF alternating voltage along conducting elements 42a and 42b is to cause electromagnetic radiation to be produced, some of which propagates downward through the earth 30. In the aboveground receiving mode, electromagnetic signals may be received from below the earth by aboveground antenna 40 and carried in the reverse manner to transceiver 58 which detects them and converts them to audible sound waves.

Belowground system 20, which may be located within an underground cavity 80, may use a similar radio receiving and transmitting apparatus which communicates with aboveground system 10 through the medium of the earth 30. Belowground antenna 70 may comprise any radiating antenna. In the illustrated embodiment, belowground antenna 70 is a center-fed half wave dipole antenna which may be suspended from the ceiling of underground cavity 80 by suspension ropes 72a, 72b, 72c, 72d, 72e, and 72f. The aforementioned suspension ropes may be suspended from roof bolts 74a, 74b, 74c, 74d, 74e, and 74f on the ceiling of underground cavity 80. Conducting elements 76a and 76b may include 10AWG stranded copper wires which may be insulated from the air by plastic sheaths along their entire lengths and at their ends by silicon sealant. The insulation provided by these materials is of sufficient strength to prevent electric discharges from the antenna wires into the environment of underground cavity 80, which may otherwise present a safety hazard by shocking mine personnel or igniting combustible materials within the cavity. Conducting elements 76a and 76b may be soldered separately to the inner and outer conductors of coaxial cable 78 at insulating strain reliever 82. Coaxial cable 78 may be of type RG-213/U and may be connected by RF connector 84a to the RF output terminal of antenna impedance matching device 86. RF connector 84a may be of the PL-259 type required by antenna impedance matching device 86, which may be the MFJ-986 Differential T Antenna Tuner. The RF input to antenna impedance matching device 86 may be connected by coaxial cable 88, which may be one meter of type RG-213/U with PL-259 type connectors on each end 84b and 84c, to the RF output connector of transceiver 92, which may be the IC-7000. Transceiver 92 may be fed power by its power cable 94 which is connected to power supply 96, which may be comprised of one or more 12 volt deep cycle AGM lead acid batteries. Transceiver 92 may be connected to a microphone 98, into which a belowground operator speaks and communicates with the operator of aboveground system 10 in like manner to the operation of the system as described above.

It is to be understood that in other embodiments transceivers 58 and 92 are replaced by separate receivers and transmitters which perform similar functions. The systems and methods disclosed herein may be utilized in connection with signals for transmission of analog or digital information and/or signals that may be converted into data (e.g., text messages or computer data streams) or for reproduction of audible information (e.g., reproduction of a voice).

In the illustrated embodiment, the dimensions of antennas 40 and 70 are such as to make them resonant at a frequency in the range of 1.900 to 1.999 MHz. The conducting elements 76a and 76b will usually be shorter than the approximately 38 meters expected for the aboveground conducting elements 42a and 42b when high enough above the ground. The frequencies between 1.900 to 1.999 MHz may be used in one embodiment because highly reliable and inexpensive equipment is readily available for this frequency range, and because it provides a good compromise between the lengths of the resonant antennas 40 and 70 and the frequency range's ground penetration capabilities. Furthermore, frequencies in this range may be used in the United States under the provisions of Private Land Mobile Radio Services, Subpart F Radiolocation Service, 47 C.F.R. §90.103, or under the provisions of Part 97 of 47 C.F.R. for communications that involve no pecuniary interest or are emergency communications. In this frequency range good communications can be expected between the surface of the earth and currently active workings in the seams of many coal mines. In other embodiments other frequencies are used according to the desired operating range, the properties and environment of underground cavity 80, and the privileges available from the appropriate radio licensing authorities. In another embodiment, frequencies in the range of 1.705 to 1.799 MHz are used with alternate transceivers that support those frequencies. In other embodiments, more useful in cases where deeper penetration of the earth is desired, frequencies in the range of 70 to 130 KHz may used under the same provisions of 37 C.F.R. §90.103. In other embodiments, frequencies between 1.7 MHz and 130 KHz, or below 70 KHz are used. In further embodiments, frequencies in the range of 3,320 to 3,400 MHz may be used under the same provisions. These frequencies may be used, for example, where the desired communication depths are not very great, or in cases where the conductivity of the earth 30 is low or the earth 30 has other properties which are conducive to better propagation. In other such circumstances, or where smaller antennas are required, or where a high amount of transmitter power is permissible, other embodiments exist which utilize frequencies across the whole HF and VHF spectra. All radio frequencies at which electromagnetic radiation can penetrate the earth to any degree may be used, even those at arbitrarily low frequencies, and even frequencies below 1 Hz, may be used in certain embodiments of the invention where sufficient subterranean space is available to allow for suitable radiating antennas. The ranges achievable through-the-earth for any given power level and earth conductivity are not inherently limited by the capabilities of the invention, but only generally by the availability of suitable spaces.

### Use of the Invention for Communication Along Earth Strata

One embodiment of the invention allows the aboveground system 10 to be positioned alongside a coal seam or other special strata where said strata exit the earth. Propagation along such strata may be superior to other through-the-earth configurations due to better propagation characteristics of such strata, such as those due to lower conductivity. Another such favorable propagation characteristic is one that is due to certain wave-guide-like propagation phenomena that may exist along strata with varying characteristics at certain frequencies. One case where such wave-guide-like propagation may be present is that of a less conductive layer sandwiched between two more conductive layers, as shown in FIG. 2. Electromagnetic radiation 102 interacts continually with the boundaries of the two outside layers of strata 34 and 36 an inner layer 38 of coal, as it propagates horizontally along seam 38, as generally illustrated in FIG. 2.

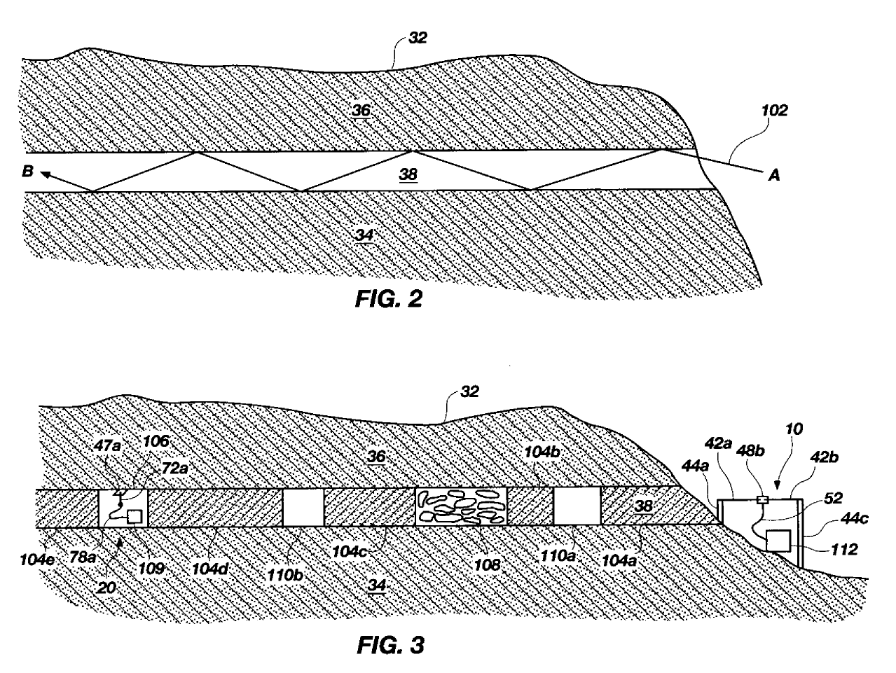

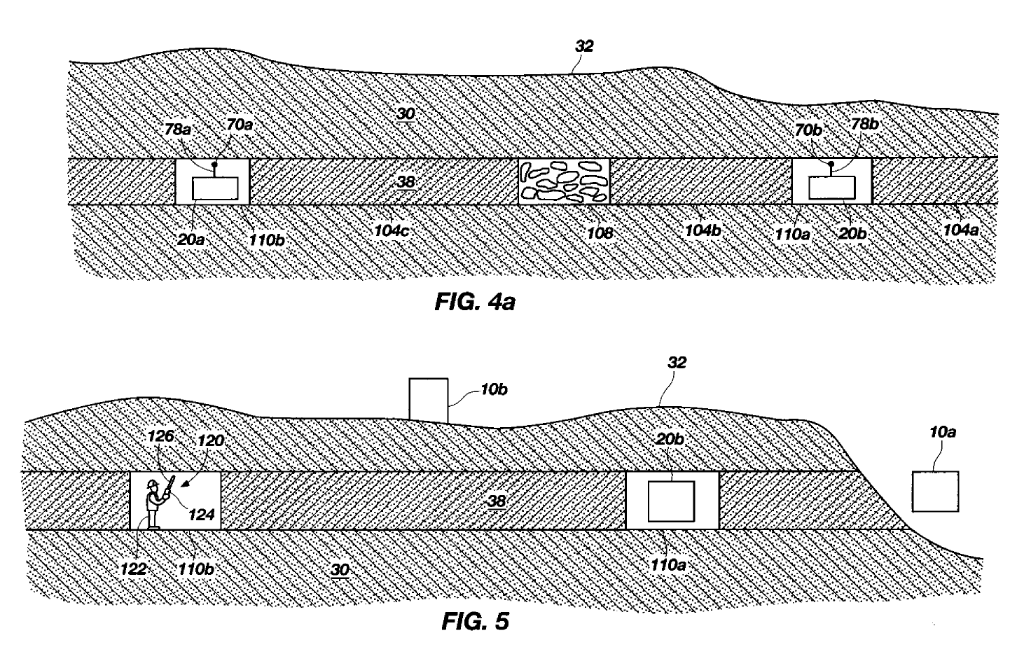

In FIG. 3, an embodiment utilizing these phenomena is illustrated. The aboveground system 10 is positioned laterally to a coal seam 38 containing the belowground system 20 in a crosscut tunnel 106 within the coal seam 38. The coal seam may contain many different sections, including for example, solid coal 104a, 104b, 104c, and 104d, gob or fallen rock 108, and other crosscuts or tunnels 110a and 110b. The parts of one embodiment of an underground system 20 that are illustrated in FIG. 3 are the roof bolts 47a, a suspension rope 72a, and coaxial cable 78a. The non-antenna components of the embodiment of an underground system 20 are represented by unit 109 in the illustration. The aboveground system 10, may be located outside the mine near coal seam 38. The parts of aboveground system 10 that are illustrated in FIG. 3 include two of the antenna support rods 44a and 44c, conducting elements 42a and 42b, insulating strain reliever 48b, and coaxial cable 52. The non-antenna components of aboveground system 10 are represented by unit 112 in the illustration. One embodiment may also include the conducting antenna elements of underground system 20 inside the coal seam 38, and the pair of conducting elements 42a and 42b outside the mine being parallel to each other as much as is possible so as to optimize the magnetic and electromagnetic coupling between them.

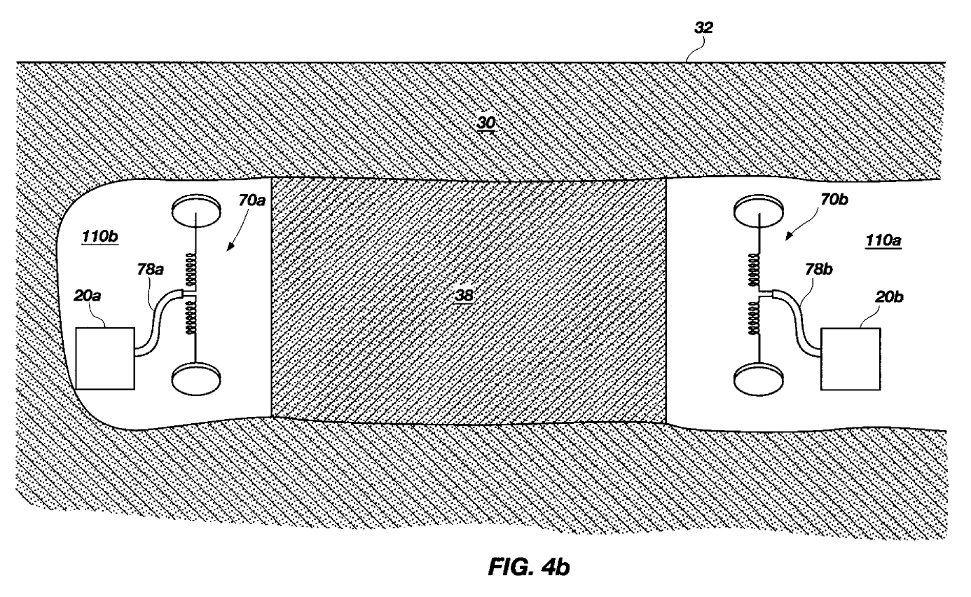

Another embodiment for enabling communication between two belowground systems 20a and 20b, each located at different points within a coal seam. FIG. 4a shows the placement of the two belowground systems 20a and 20b in two different crosscuts 110a and 110b in coal seam 38, separated by sections of coal 104b and 104c and gob or fallen rock 108. Although all the components of belowground systems 20a and 20b are not shown, they both include the same components as belowground system 20 previously described with reference to FIG. 1. In one configuration, the antennas of belowground systems 20a and 20b may be as parallel to each other as is possible. Since coal workings typically have tunnels in two perpendicular directions, in this embodiment, using tunnels of the opposite directions should be avoided.

Another embodiment of the invention which similarly facilitates communication between two belowground systems 20a and 20b, each located at different points within a coal seam, is shown in FIG. 4b. In this case, the antenna 70a and antenna 70b may be oriented vertically, instead of horizontally as they were in FIG. 4a. In order to fit the antennas 70a, 70b in the relatively short vertical space available in crosscuts 110a and 110b, antennas 70a and 70b may be shortened using the methods of inductive and capacitive loading, which methods are described in more detail below. The vertical orientation of the antennas causes radiation to propagate in different transverse electric (TE) or transverse electromagnetic (TEM) modes along whatever wave-guide-like conditions exist at the frequency in use in the particular coal seam 38, than those wave-guide propagation modes which would be excited by the horizontal antenna orientation of antenna 20a in FIG. 4a. The propagation mode excited by antennas 70a and 70b in FIG. 4b may result in lower attenuation along the path between the two belowground systems in crosscuts 110a and 110b for certain frequencies. Another advantage of this vertical polarization is that the radiation from antennas 70a and 70b will be strong in all horizontal directions and therefore useful for communication with other belowground systems throughout the mine, whereas the horizontal antennas 70a and 70b will generally produce strong signals in the directions along the coal seam 38 that are somewhat perpendicular to the antenna elements of antennas 70a and 70b.

### Use of the Invention for Intra-Mine Communication

As shown in FIG. 5, one embodiment of the invention is to have one or more aboveground systems 10a and 10b outside the mine, and/or one or more belowground systems such as 20b, any of which communicate with one or more portable systems such as handheld system 120, carried or otherwise utilized by mining personnel such as miner 122 inside a mine. It is to be understood that portable handheld system 120 is a merely one representation of many kinds of portable or mobile systems that may be used by underground personnel, such as a system that is attached to a vehicle, or carried in a backpack or on a belt, or attached to some location in the mine where circumstances do not permit larger systems as illustrated, for example, by underground system 20 in FIG. 1. Handheld unit 120, may include a handheld transceiver 124 utilizing HF frequencies and a short, inductively base loaded antenna 126, of the kind commonly found in military or amateur use. In one embodiment, the handheld unit 120 will not typically utilize higher VHF or UHF frequencies, although they may communicate with other existing units that do. HF radiation, as utilized by the present invention in handheld unit 120 can achieve appreciable propagation through coal pillars and other obstacles, as well as along line-of-site channels, and in addition, can bend around corners and obstacles and can follow curved tunnels through the phenomena of diffraction, refraction and reflection. It is obvious that multiple HF handheld units 120 can be used by multiple personnel within a mine 38 to communicate between each other, as well as with fixed above and belowground systems such as 10a, 10b, and 20a. Such portable systems are highly desirable because of their convenience. However, in one embodiment, the range of HF handheld units 120 may be less than that of fixed belowground systems which are likely to be capable of radiating more power and/or utilizing larger and more efficient antennas.

Taking the advantages and disadvantages of handheld HF units and fixed above and belowground systems, one embodiment of such a system may utilize both types. Fixed aboveground systems 10 used along with fixed belowground systems 20 can provide communications over larger distances through-the-earth than those that are available through other systems. Such capabilities are especially helpful in emergency situations where all other techniques for communicating from inside a mine to the outside may have been destroyed. Fixed belowground systems 20 may be best deployed in protected areas such as refuges and shelters for miners. When such systems survive an emergency situation they can provide through the earth communications for personnel carrying handheld HF devices in other locations as well as for personnel who are within said shelters or refuges. In certain scenarios, it is more likely that a miner carrying handheld HF unit 120 will be able to communicate over practical distances through coal seam 38 to a fixed belowground system 20 than it will be for the same handheld I-IF unit 120 to communicate through the earth to an aboveground system 10. In such cases, then, belowground systems 20 may be employed as repeaters between portable HF handheld units within the mine 38 and aboveground systems 10. In such configurations, it is possible that the ideal frequencies for propagation and convenience within the mine 38 between handheld HF unit 120 and belowground system 20 may be different and likely higher, than those that are optimal for communication between belowground system 20 and aboveground system 10. In such cases, when belowground system 20 is being used in both modes, or as a repeater, it should be designed to utilize both of the different optimal frequencies.

Use of the Invention with Other Underground Communications Systems

The invention may be used in conjunction with other types of underground communications systems. Communication systems such as leaky feeder systems, mesh systems, portable UHF radios, locating systems, paging systems, telephone systems may all be interfaced with a belowground system 20 of the present invention, with or without wires. In one such scenario belowground system 20 may provide communication with certain areas of a mine which are not covered by other systems. In another such scenario the belowground system 20 may provide communication between the surface and the interior of a mine and then link to one of the above systems which provide communications between areas within the mine. In this way, ordinary day-to-day communications may be enhanced by the through-the-earth link which also provides emergency communications to the interior of the mine even if all communication from all the other interior systems to the surface fail yet will remain at least partially usable within certain areas of the mine.

The present invention may be used, for example, in conjunction with existing RFID systems, which record the location of miners as they move past certain checkpoints in a mine. In an emergency, such location information may be communicated from such RFID systems to a belowground system 20 by either manual or automatic techniques and thence relayed through-the-earth to the surface or elsewhere within the mine for the use of rescue personnel. This same relaying of data from other mine systems through the TTE link, could also be used on a routine (non-emergency) basis for sending information from remote areas in the mine to the surface (or other areas in the mine).

### Utilizing Short Radiating Antennas

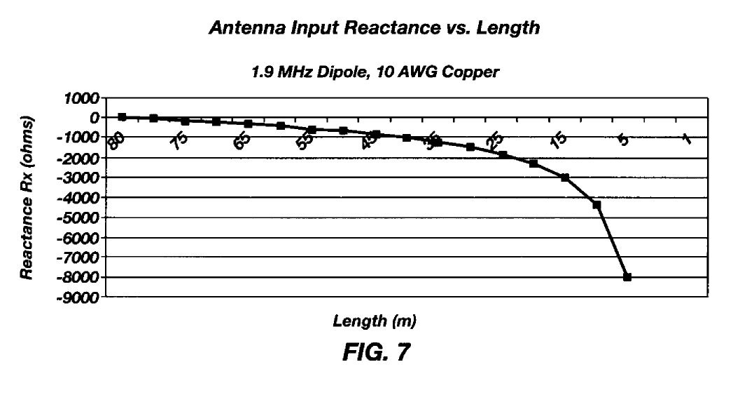

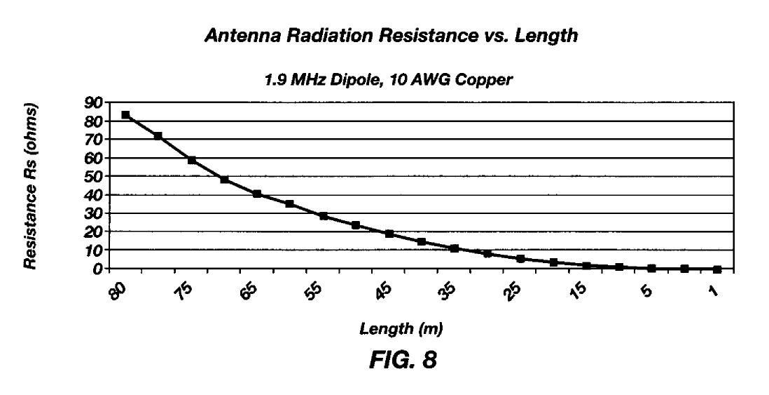

The disclosed systems and methods may utilize certain methods for shortening a radiating antenna to less than the dimensions of its natural resonance. In certain cases, this can be done without sacrificing too much efficiency to be useful for many underground applications. When a full-sized, resonant antenna is made shorter, its input impedance changes as shown in FIG. 7 and in FIG. 8. The antenna shown is a center fed dipole made of from 10 AWG copper wire and fed with RF power at 1.9 MHz in free space.

The resistive or real component of the antenna's input impedance, or in other words its radiation resistance, decreases as the radiating elements lengths are shortened as shown in FIG. 8. The reactive component also decreases as the antenna is shortened as shown in FIG. 7, becoming a large negative value. The negative sign signifies that the reactive component is capacitive. In one embodiment, both effects must be dealt with in order for a shortened antenna to work efficiently.

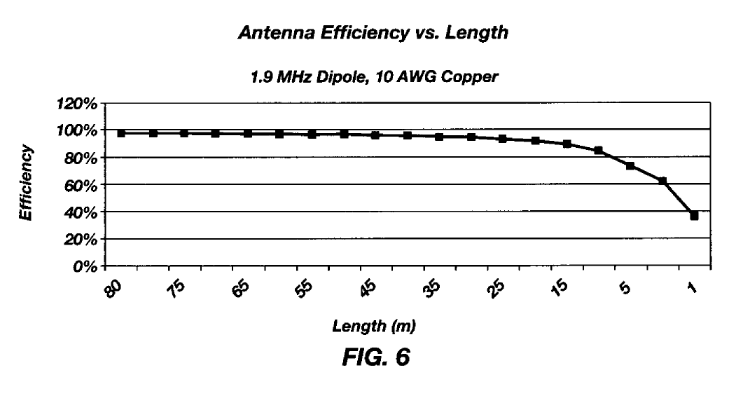

Referring to FIG. 6, it is seen that the radiation efficiency of the same dipole depends on its length. This is because the efficiency of an antenna depends on the ratio of its radiation resistance, R_{radiation}, to its total resistance, including the resistance, Rₒₜₕₑᵣ, that is associated with all other power losses that are not due to the actual radiation of energy:

Radiation Efficiency=R_{radiation}/(R_{radiation}+Rₒₜₕₑᵣ)

At first glance, FIG. 6 may seem to show that a dipole antenna can be significantly shortened before losing much in efficiency. However, the losses shown in FIG. 6 are only those losses that occur in the antenna's elements, and do not include other losses that will occur in any matching circuitry or transmission lines. In reality, when these factors are taken into account, the entire system around the dipole antenna under consideration will show much greater losses at short antenna lengths.

The low radiation resistance of a short antenna becomes much lower than that of the output impedance of practical RF generating transmitters. In order to efficiently transfer power into the antenna where it may be radiated, and in order to avoid wasting energy in the output stages of the transmitter and avoid damage to the transmitter, it is necessary to transform the antenna's radiation resistance to match the value of the output of the transmitter. As the radiation resistance becomes lower than about 10 ohms, increasing amounts of power will begin to be lost in any practical impedance matching system, increasing without limit as the antenna is further shortened. Furthermore, the extremely high reactance of the shortened antenna must be cancelled by the same impedance matching system, resulting in further losses thereby.

All losses in the antenna system can be compensated for by feeding the antenna with more power. However, providing higher power output from the transmitter naturally brings other disadvantages. Therefore, making the antenna system more efficient can be thought of as reducing the transmitter power requirements, or alternatively, as increasing the through-the-earth range achievable with a fixed transmitter power.

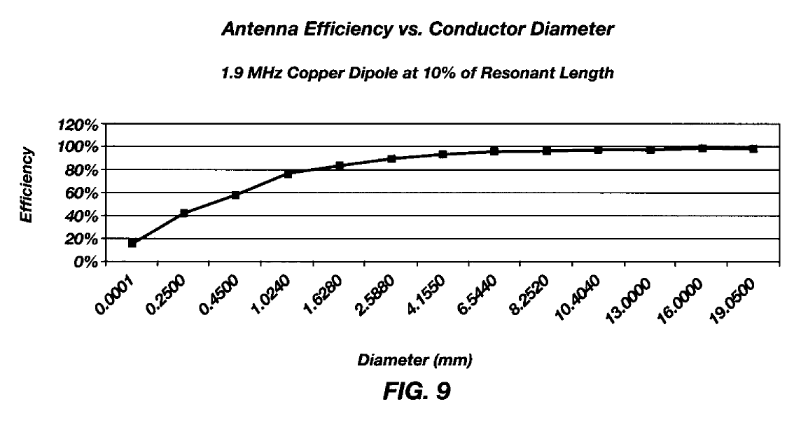

A large part of these losses are typically due to resistive losses in the antenna's conductors, as well as the conductors of matching inductors, capacitors, and transmission lines. The effect of the former, as represented by the diameter of the conducting elements of the same shortened dipole, on the antennas radiation efficiency is shown in FIG. 9.

Therefore, in one embodiment, conductors of large diameters are employed. At the relatively high frequencies used in the invention, the skin effect causes most of the RF current in the antenna to be conducted on the surface of the conductors. Therefore, some embodiments of the invention may utilize tubing or pipe for conductor elements, rather then heavier and more costly, thick, solid conductors.

In order to minimize non-radiation energy losses, low resistance materials may be used for all conductors. Copper has a relatively low resistance and is used for the conductors of one embodiment of the invention. Silver is an even better conductor than copper but will be cost-prohibitive in certain situations. However, because of the aforementioned skin effect, which occurs at the higher frequencies utilized by some embodiments of the invention, silver plating is effective at reducing resistive losses and is more economical than solid silver conductors. In one embodiment of the invention, silver plated copper tubing is used for all antenna conductors and matching coils.

It is also the case that the resistance of various highly conductive metals such as copper, aluminum, and silver decreases with decreasing temperature. Therefore, in some embodiments of the invention, the natural cooling in underground chambers is utilized to reduce antenna losses, and, in other embodiments, the resistance of the antenna conductors is further reduced with artificial cooling. In particular, cooling fluids such as liquid nitrogen may be forced through the tubing or pipes that already comprise these conductors. Such cooled conductors may also be contained within plastic or other insulating tubes or vessels to isolate the cooling liquid and the conductors from the air.

The radiation resistance rises without limit as radiating antennas get very short. This places practical limits on the degree of shortening possible with normal metallic conductors. However, superconducting materials exist which have exactly zero resistance and can be used to create arbitrarily short antennas. Therefore, in situations where extremely small antennas are desired and provide sufficient economic benefits, superconducting antenna elements, though more costly, may be employed. One embodiment of the invention utilizes a short dipole of approximately a meter in length with very thin conducting elements and matching coils made of some HTS superconductor, such as YBCO or BSCCO, cooled with liquid nitrogen at its boiling temperature of 77K and operating at about 100 KHz. This configuration can provide an extreme degree of shortening when compared with the natural resonant length at this frequency. The advantage in such embodiments is that the high ground penetration of lower frequencies can be achieved simultaneously without impairing radiation efficiency.

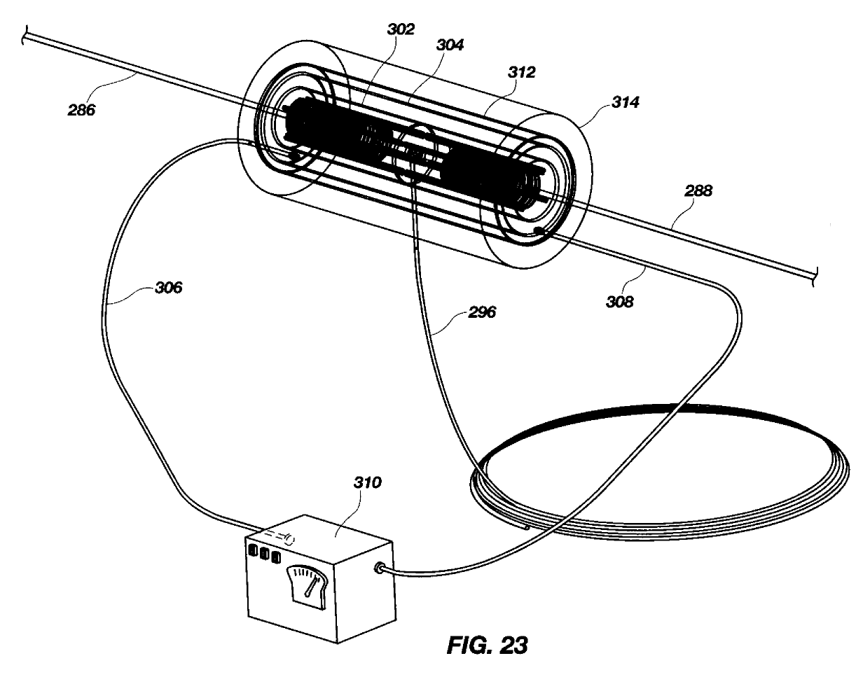

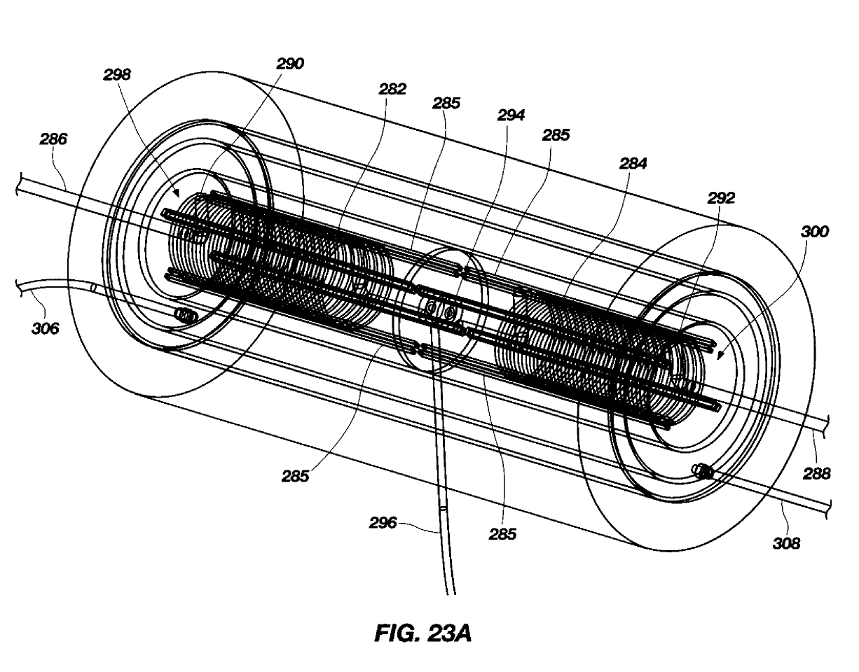

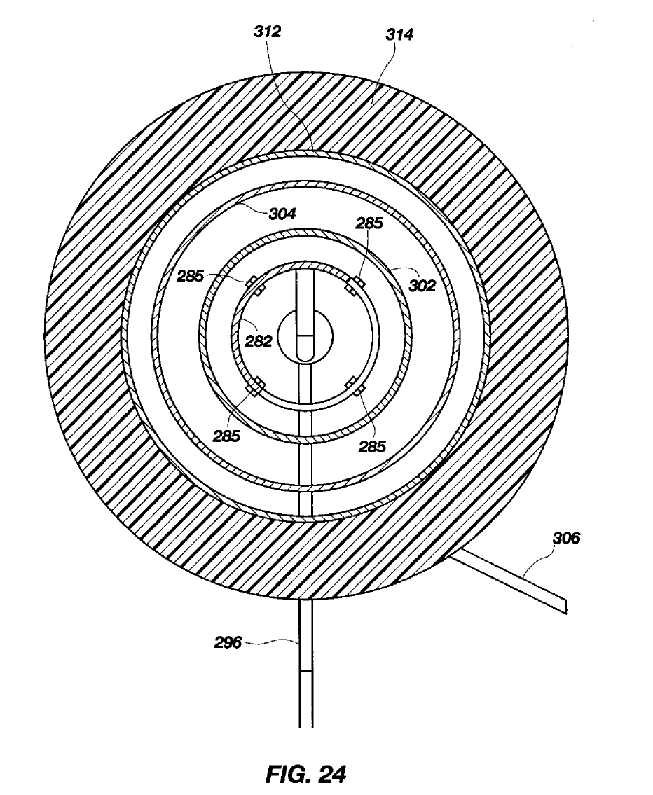

When making use of superconductive elements in the antenna system, it is likely that a better result will be obtained by using superconducting matching components such as loading coils, rather than making the antenna elements themselves superconducting, because higher currents may be circulating in a smaller volume in such components in comparison with the antenna elements themselves. One embodiment of the invention wherein superconducting loading coils are used with a shortened dipole is illustrated in FIGS. 23, 23a, and 24. The said shortened dipole 280 obtains inductive loading from coils 282 and 284, which are comprised of a superconducting material, such as the superconducting 2G 344C YCBO wire material manufactured by AMSC. It is desirable for the superconducting wire to be kept away from dielectrics which may introduce losses, so the wire is first wound on a tubular form, and then the forms is removed and the wires are mechanically held in their cylindrical, one-layer coil form by strips of PTFE. The 344C wire has tinned surfaces so the wires comprising coils 282 and 284 are joined by silver solder to copper wires 286 and 288 on the outer ends of coils 282 and 284 at points 290 and 292 which are the radiative conducting elements of the dipole 280, and on the other end to connection point 294 which comprises the feed point of the antenna, which is connected to coaxial cable 296. The ends of coils 282 and 284 are attached to circular disks of Teflon 298 and 300 for mechanical stability. The coil assemblies 282 and 284 are contained in glass container 302 which is hermetically sealed and contains gaseous helium. The purpose of the helium is to provide a non-liquefied environment for the coils, resulting in a material with lower dielectric constant and a lower loss tangent than would be obtained from immersing the wires in liquid nitrogen directly. The glass container 302 is contained concentrically within another cylindrical glass container 304, which is also hermetically sealed and filled with liquid nitrogen. Hoses 306 and 308 circulate said nitrogen to and from cryogenic cooling device 310. In order prevent heating of glass container 304 from the ambient atmosphere, a third glass container 312 is mounted around glass container 304 concentrically and the air is partially evacuated from said third glass container 312, forming the cavity of a Dewar containment device. All glass containers are non-silvered. The third glass container 312 is mounted within a foam polystyrene cylinder 314 for thermal insulation and protection. The assembled unit provides a zero resistance inductive load at the center of dipole 280, which when tuned properly with antenna conductors 286 and 288 produces a resonated, shortened dipole antenna of improved efficiency. In another embodiment, high Q vacuum capacitors and additional HTS superconducting coils may be added within the cavity of glass container 302 and connected to coils 282 and 284 to create L, pi, or T matching circuits, and to thereby raise the feed point resistance at connection point 294 and provide a good match to coaxial cable 296 connected to said connection point 294.

Losses in the medium surrounding an underground antenna, such as the earth, are not considered in the efficiency calculations indicated above. Such losses may occur throughout the propagation path through the earth regardless of what kind of antenna is used, and so are not necessarily to be considered as losses of the antenna itself. However, it is advisable in practice to try different locations and positions of the antenna relative to underground earth and other media and measure the through-the-earth path loss to determine the best antenna placements. These losses depend greatly on the conductivity and configuration of the materials through which the radio signals pass. In particular, underground water containing dissolved salts produces high propagation losses and should be avoided to whatever extent is possible. As noted previously, losses in the propagation medium can be expected to be reduced as the frequency used is reduced.

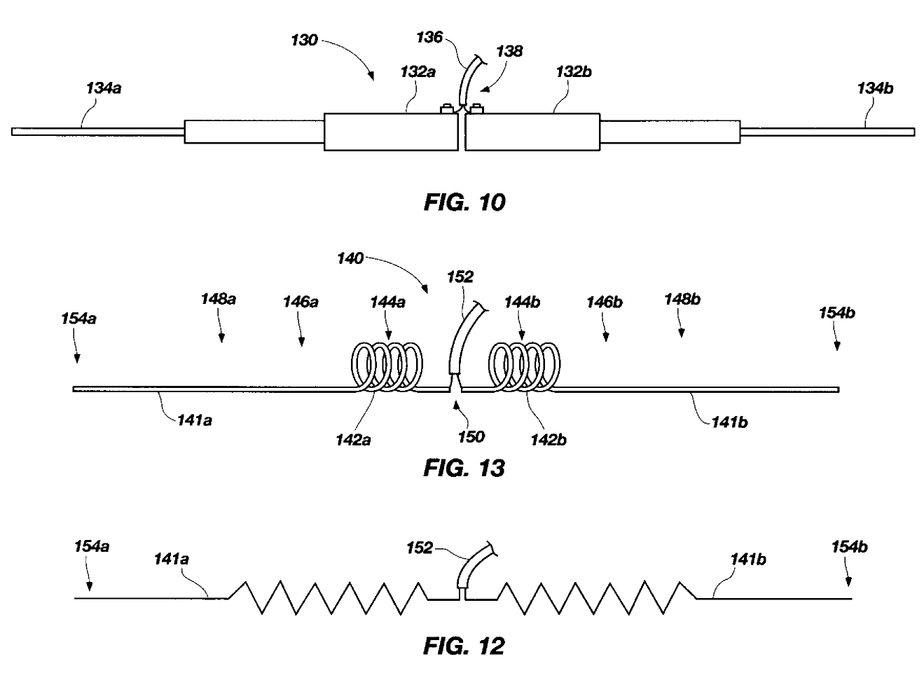

When radiating antennas are shortened, the amount of RF current flowing in the antenna and matching system conductors increases when the antenna is fed with a constant RF input power. The amount of current carried in different parts of the antenna's conductors will vary. Therefore, the effectiveness of large conducting elements in these locations is greater than in lower current regions. To take advantage of this effect, in one embodiment, the conducting elements 132a and 132b of a shortened dipole 130 are tapered down towards their end conductors 134a and 134b as shown in FIG. 10. This is because in a dipole large currents flow in the center and become smaller toward the ends and the losses are less significant there. In the embodiment illustrated, the antenna is fed at the center of the antenna at feed point 138 by transmission line 136.

Embodiments of the invention may utilize an antenna modeling and analysis computer program, which uses the electromagnetic method of moments, such as NEC, NEC-2, NEC-4, or MiniNEC, in order to determine where the RF currents are highest and where large conductors are most needed.

The same program may also be used to determine what the voltages will be at all points on the antenna. This latter information may be used to determine what precautions need to be taken to ensure that the antenna is safe in the environment where it will be used, since at high enough voltages the antenna may produce arcing, sparks, and corona discharges at certain points.

The same modeling programs may be used in certain embodiments to determine the losses and impedances of various potential antenna designs for a given proposed location in advance and to create a rough design for a specific TTE application, taking into account the sizes and shapes of the underground spaces, the portability required, costs of materials, and other factors. The exact dimensions must be determined with the antenna in place as described below.

### Methods of Shortening Radiating Antennas

Three general classes of methods present themselves for compensating for the changed impedances of a shortened antenna. These are linear loading (otherwise known as meanderline loading), capacitive loading, and inductive loading. In one embodiment, a center-fed half wave dipole, which is an efficiently radiating antenna, is shortened using any of the above three. The same techniques may be applied to many other kinds of radiating antennas in other embodiments.

### Shortening Antennas Through Linear Loading

In embodiments of the invention where antennas are shortened through linear loading, the antenna's conducting elements may be reconfigured to have increased overall length, or in other words, greater electrical length, while the length between the ends of the antenna, or in other words, its horizontal, physical length is shortened. In such a way linear loading may allow a shorter horizontal length, while maintaining the antenna's resonance.

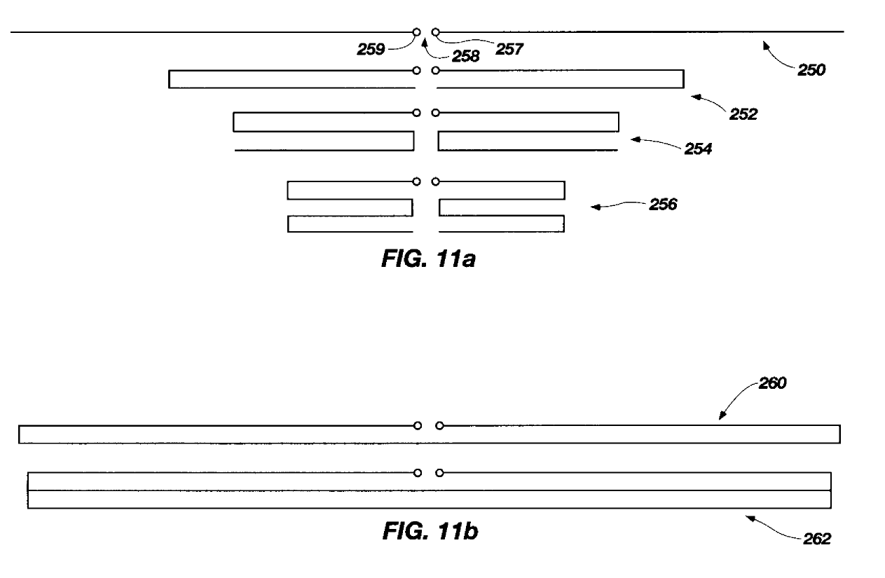

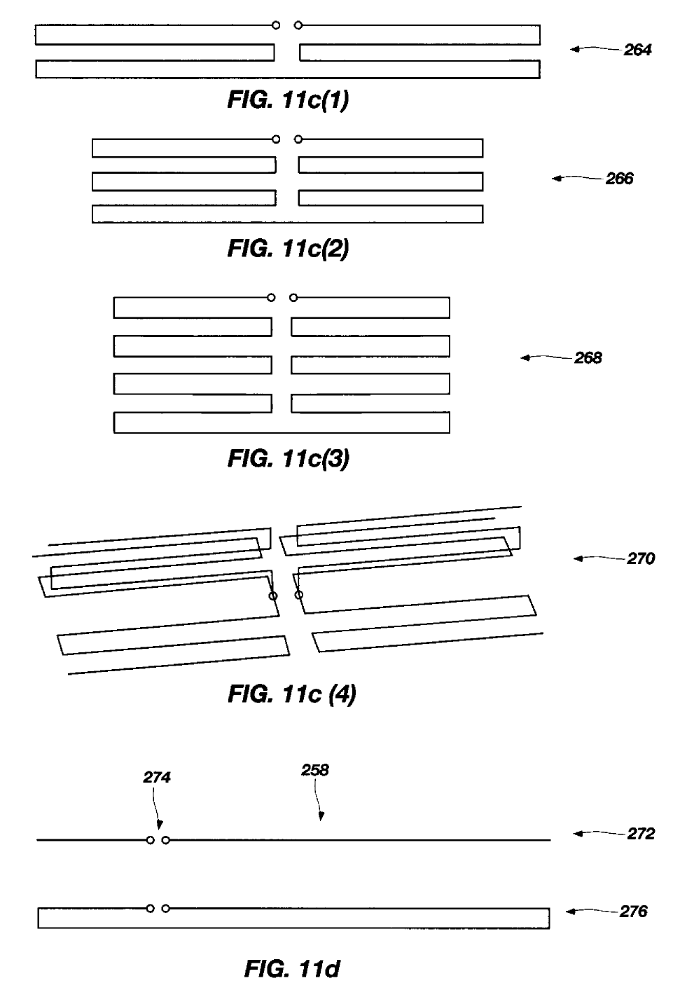

Several such configurations are shown in FIG. 11a. Center fed half wave dipole 250 is shown in order to illustrate the shortening of the linear loaded antennas 252, 254, and 256 relative to it. In each case, the antennas may be fed between the two circles 257 and 259 depicted at feed point 258. In the illustrated embodiments, each shortened dipole shown is resonant, but the radiation resistance of each has decreased from the normal 72 ohms of antenna 250. For example, shortened dipole 252 may have 28 ohms of radiation resistance, antenna 254 may have 12 ohms, and antenna 256 may have 5 ohms. These shortened, resonant antennas may be matched to the impedances of typical transmitters and without large losses in the impedance matching device.

Another form of linear loading is illustrated in FIG. 12, in which the conducting elements 141a and 141b are electrically lengthened by a pattern of zigzags. The illustrated antenna becomes resonant when elements 141a and 141b are shortened. Hence, this method can be used to resonate the shortened forms of all kinds of antennas in a way similar to that of the other forms of linear loading referred to above. Many other geometrical patterns besides the zigzag pattern illustrated in FIG. 12 can be used to produce the same effect.

### Shortening Dipole Antennas Through Inductive Loading

Another embodiment of the invention utilizes techniques of shortening a radiating antenna, such as inductive loading of a dipole antenna, as illustrated by antenna 140 in FIG. 13. In this case, one or more pairs of inductors 142a and 142b are inserted at points 144a and 144b, 146a and 146b, and 148a and 148b, or other points along conducting elements 141a and 141b not too far from the center 150 of the antenna where transmission line 152 may be used to feed the antenna. In one extreme case, the coiled inductors 142a and 142b may extend from the center point 150 all the way to points 154a and 154b. In this embodiment, the antenna elements essentially becomes continually coiled wires of inductors 142a and 142b. The diameter of said coils may be of relatively small diameter relative to the wavelength.

### Shortening Dipole Antennas Through Capacitive Loading

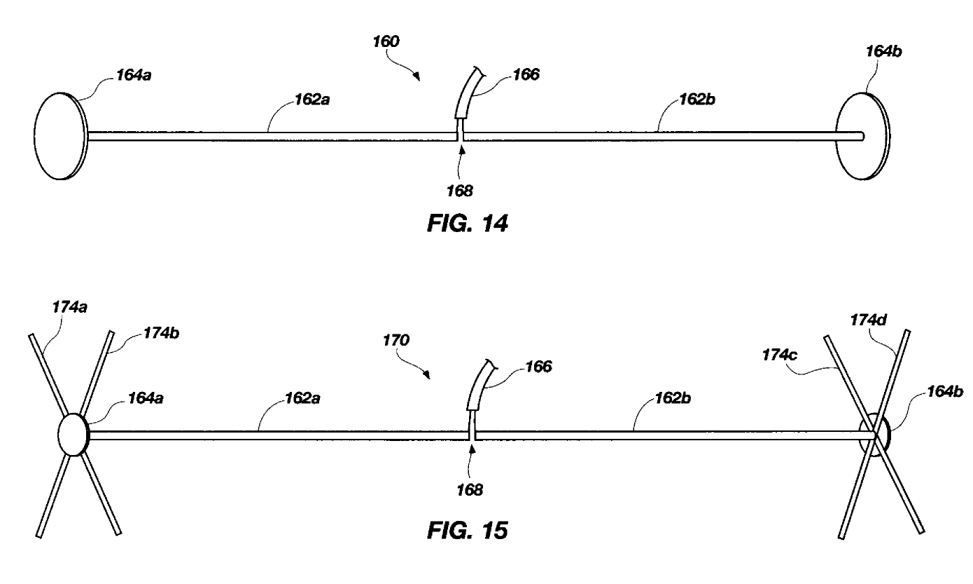

Another embodiment of the invention may utilize techniques for shortening a radiating antenna, such as capacitive loading of a dipole antenna, as illustrated by antenna 160 in FIG. 14. In this case, conducting plates 164a and 164b may be electrically and mechanically attached to the ends of the main conducting elements 162a and 162b away from the center point 168 of the shortened dipole 160, or some other points between the center 168 and the ends of 162a and 162b. Transmission line 166 is used to feed the antenna.

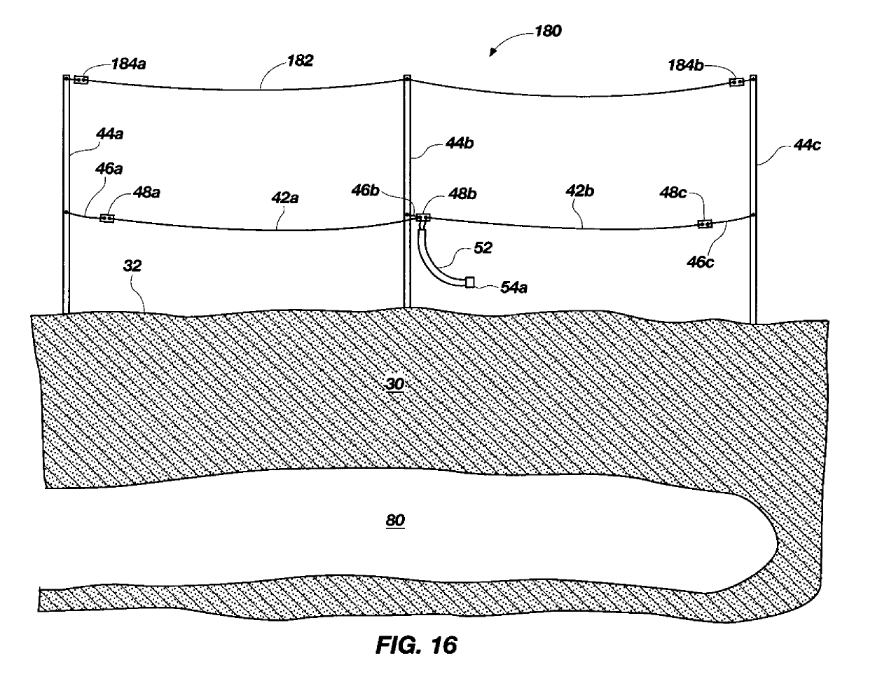

Alternatively and/or in addition, the conducting plates 164a and 164b may be augmented or replaced by conducting rods 174a, 174b, 174c, and 174d, as illustrated in FIG. 15. Many other configurations of rods, plates, meshes, or other conducting materials may be used at or near the ends of conducting elements 162a and 162b. In each case, the materials and shapes are chosen to provide additional capacitance near the ends of conducting elements 162a and 162b. It is desirable to increase the capacitance between the two conducting plates 164a and 164b along the axis of the antenna without increasing the capacitance between each of said plates 164a and 164b to the surrounding earth. This is because increased capacitive coupling from the conducting elements of the antenna to the earth may cause increased power losses due to the poor dielectric properties of said earth.

The effect of the added capacitance is to increase the radiation resistance, and decrease the reactive part of the antenna's impedance, which otherwise would have to be compensated for through some other technique. Capacitive loading typically will produce lower losses than other techniques, such as inductive loading. Antennas shortened through capacitive loading also may exhibit wider bandwidths than those shortened by other techniques.

### Shortening Folded Dipoles Antennas

In another embodiment a center-fed half wave folded dipole is shortened using the methods of linear, inductive, and capacitive loading. FIG. 11b shows normal sized two and three wire folded center fed dipole antennas, 260 and 262 respectively, both of which are slightly shorter than the equivalent non-folded dipole 250 in FIG. 11a. These two folded dipoles exhibit much higher radiation resistances at resonance than the equivalent non-folded dipole 250. Therefore, when they are shortened and loaded linearly, the resulting radiation resistances are much higher than those of the equivalently shortened non-folded dipoles shown in FIG. 11a. In the illustrated embodiment of FIG. 11c, the shortened, linear loaded dipole 264 has radiation resistance of 100 ohms, dipole 266 has 53 ohms, and dipole 268 has 34 ohms. These radiation resistances are in or near the ideal range of 50 to 72 ohms typical of normal full sized non-folded dipoles and where transmitters and receivers typically operate. Therefore, dipole antennas 264, 266, 268, and 270 are very short, resonant antennas that can be fed without the need for significant impedance matching and without any associated losses.

### Shortening Off-Center Fed Dipole Antennas

Another kind of antenna may be used in a different embodiment of the invention which has naturally high impedance in its full size form, and therefore is amenable to efficient impedance matching when shortened, is an off center fed dipole, which is depicted in FIG. 11d. Such an antenna 272 is fed at a point located some distance to the left or right of the normal center feed point, 258, such as at point 274. As point 274 is moved further from point 258 toward the extreme end of the antenna the radiation resistance increases without limit, so this method is yet another way to increase the radiation resistance of a dipole that has been shortened by one of the methods given above. This kind of dipole can be used in its non-folded and folded forms, 272 and 276 respectively.

### Other Short Radiating Antenna Types

Combinations of the linear, inductive, and capacitive loading methods may be used together to produce efficient radiation from certain dipole antennas. Other kinds of resonant, radiating antennas that are in common use aboveground utilize long conducting elements similar to those utilized by dipoles, and such elements may be shortened in length while maintaining resonance by applying the linear, inductive, and capacitive loading methods illustrated above, or combinations thereof. Other embodiments of the invention utilize such antennas, in both their shortened and normal sized forms.

One such embodiment utilizes loop antennas as efficiently radiating antennas by using the proper loading techniques. Linear and inductive loading techniques similar to those described above allow the loop to be resonant at a size far below the natural resonance size, which is on the order of 3,000 meters for a 100 KHz antenna. As mentioned earlier the terminology in the art regarding loop antennas is confusing, and it must be realized that the kind of radiating loop antenna just described is different in nature from the magnetic loops used in the prior art, even though superficially they may look the same. The sizes, impedances, and electromagnetic radiating properties are entirely different in the two cases. Other methods for shortening antennas, including a combination of one or more of methods and systems disclosed herein, may be employed.

### Antennas for Use Aboveground

Referring back to FIG. 1, the aboveground antenna 40 may be an important part of the radio link to the underground system. It is expected that, in certain cases, there will be considerably more flexibility in the choices available for aboveground antenna 40, compared to those available for underground antenna 70. Any optimizations in the efficiency of aboveground antenna 40, measured in decibels, will give the same benefit to the overall through-the-earth communication link as those of the same magnitude made underground, and may be more economically done in many cases.

Almost all kinds of antennas normally used aboveground in the MF and HF frequencies in other communications fields, can be used in the same manners and at their typical, half wavelength sizes, or alternatively, depending on the requirements and circumstances, they can be effectively shortened using the same loading techniques heretofore described, to become useful in one kind or another of through-the-earth communications.

We note here two particular criteria that may be used when determining the best antenna for use aboveground in through-the-earth communication systems. Firstly, the aboveground antenna 40 may be horizontally polarized, as shown in FIG. 1. This is because electromagnetic coupling between any two antennas is optimal when the antennas are identically polarized, and since only generally horizontal polarization may be usable for the underground antenna 70, aboveground antenna 40 may utilize the identical polarization. Even in those cases where underground antenna 70 is actually short enough to be vertical within underground cavity 80, dipole type antennas, shortened or otherwise, radiate poorly in directions perpendicular to their principal conducting elements, in this case 76a and 76b. In other words, an antenna so oriented will not radiate effectively in the vertical direction toward aboveground antenna 40.

Secondly, in certain scenarios, it is preferred to put the antenna 40 some distance above the surface of the earth, because otherwise, if it is directly on or close to the surface of the earth 32, energy from the antenna 40 may be coupled with the earth, which coupling may lower the antenna's efficiency. Although it might be thought that coupling more energy from antenna 40 directly into the earth 30 is exactly what is called for, since radiation in that direction is desired, such may not generally be the case. In certain embodiments, when the antenna conductors are near the earth, increased currents flow between the conducting elements 42a and 42b via certain paths of finite conductivity in the earth 30 because of the capacitive coupling between each of the conducting elements 42a and 42b to these paths in the earth 30. Such currents cause the loss of power through the natural resistances and dielectric losses along said paths in the earth. But even if these losses are minimal, as would be the case where the earth material 30 has extremely low resistance, these currents still have the effect of reradiating and canceling out the radiation from antenna 40 in the desired direction through the earth through destructive interference, thereby reducing the amount of radiation that actually penetrates the earth. In the extreme case where the conductivity of the earth 30 is perfect, no radiation at all will penetrate the earth due to this cancellation effect.

Such electric coupling of the antenna to the earth may be manifest by a decrease in the resonant length of the antenna 40, or in other words, a shortening of the resonant length of the antenna, relative to what it is at greater height above the surface 32. Although this decrease in length may be seen as desirable, it may be indicative of the concomitant losses in the earth 32 and cancellation of said downward radiation just described.

### Directional Antennas Above and Below Ground

The degree of penetration of electromagnetic energy through the earth at many frequencies can be increased by the use of directional antennas and antenna arrays that provide forward gain in a certain direction. Referring again to FIG. 1, in the case of the aboveground antenna 40 being comprised of a non-directional antenna, such as a dipole as shown, a majority of the radiation may be radiated into space and every other direction besides the desired direction down into the earth and is wasted. Furthermore, in the receiving mode interfering noise and radiation may be received from these directions with said non-directional dipole antenna 40. However, much of this otherwise wasted energy can be directed into the earth replacing the non-directional dipole 40 with a directional antenna.

One such directional, radiating antenna is a yagi antenna. The yagi antenna, and other kinds of directional antennas designed for ordinary radio use aboveground, is typically made of solid metal rods or tubes. However, they may also be effectively made of wires, which renders them more practical at lower frequencies where relatively long conducting elements may be required. Furthermore, yagi antennas can be shortened substantially by the loading methods discussed earlier without compromising performance too much.

In one embodiment of the invention, a wire yagi antenna 180 on the surface may be constructed as depicted in FIG. 16. The illustrated aboveground antenna 40 may be modified by the addition of wire conductor 182 parallel to and above the conducting elements 42a and 42b. Antenna support rods 44a, 44b, and 44c may be extended to support the higher conducting element, and insulating strain relievers 184a and 184b may be added to hold wire conductor 182 in place. In the illustrated embodiment, wire conductor 182 is continuous from its connection to 184a and 184b. Wire conductor 182 is slightly longer and the combined lengths of conducting elements 42a and 42b. Thus, wire conductor 182 becomes the reflector element of yagi antenna 180, and conducting elements 42a and 42b together make up its driven element, fed as before by coaxial cable 52.

The distance separating the reflector and driven elements of a two element yagi antenna, such as is illustrated in FIG. 16 can be reduced to 0.06 wavelengths and below without sacrificing gain. In fact, a 0.06 wavelength separation may yield better gain that a more typical separation of 0.14 wavelengths. Accordingly, the conducting elements 42a and 42b may be separated from wire conductor 182 by distance of approximately 9.5 meters and oriented so that antenna 180 “shoots” downward in the desired direction toward underground cavity 80. In this case, the downward gain of antenna 180 may be on the order of 7 dBi. In another embodiment, said yagi has a multiplicity of such parasitic wire elements for further gain.

In other embodiments of the invention, the conducting elements of the yagi antenna represented by aboveground antenna 180 in FIG. 16 are shortened by the use of linear, inductive, and capacitive shortening.

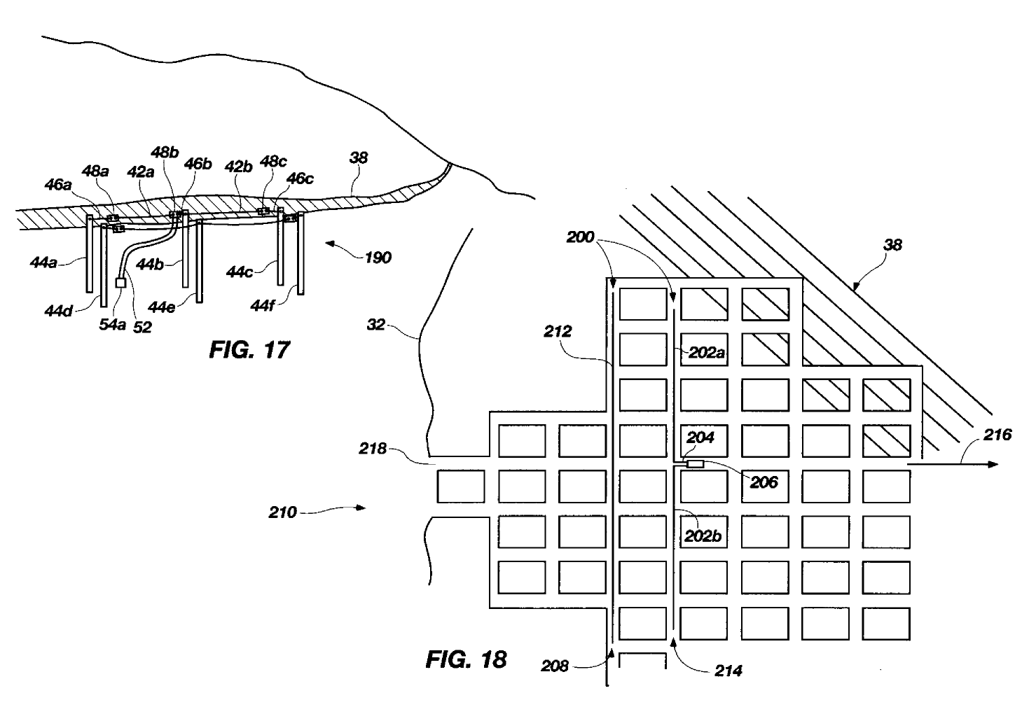

In another embodiment, an aboveground yagi antenna 190 above the surface of the earth 32 may be constructed of wires placed adjacent to the coal seam 38 outside the mine so that it “shoots” into the seam 38 giving broad coverage of all, or some part of, the coal mine, as shown in FIG. 17. This configuration may use all the components of the configuration shown in FIG. 16, though not all are shown, along with the introduction of three more antenna support rods 44d, 44e, and 44f. The wires may be substituted with rods or tubes.

In FIG. 18, yet another embodiment of a yagi antenna for use in communications throughout a coal mine 210 is illustrated. The diagram of FIG. 18 is a top view looking down upon the illustrative pillars and rooms of the mining works along an illustrative coal seam 38. Belowground yagi antenna 200 may be created within the coal mine 210 by putting conducting elements 202a, 202b along crosscut 208 to create the driven element of yagi antenna 200 fed by coaxial cable 204 which is connected to belowground system 206, which is of a similar nature to that of FIG. 1, exclusive of antenna 70, which is illustrated in FIG. 4a as belowground system 108. Conducting element 212 is placed in adjacent crosscut 208 and to form the reflector element of the yagi antenna 200. The yagi antenna 200 can thus be made to “shoot” in the direction indicated by arrow 216, into the portions of the mine to where communication is desired. Antenna 200 may be placed relatively close to mine portal 218 to provide communication from outside of mine 210 without the structural issues and inconvenience of utilizing an outside antenna such as antenna 190 in FIG. 17, or in cases where the coal seam does not meet the surface of the earth 32.

In the embodiment shown in FIG. 18, a lower frequency of about 400 KHz is utilized, as dictated by separation the natural distance between crosscuts 208 and 214, and to utilize longer conducting elements to take advantage of the space available along crosscuts 208 and 214, thereby achieving much greater range along the coal seam because of the superior range of radiation provided by such a lower frequency through partially conducting materials such as coal.

It is to be observed that radiation from antennas along strata such as coal such as that produced by antennae 190 and 200 in FIGS. 17 and 18 is not intended to propagate through the medium of other existing conductors within the mine such as power wires and beltways, and in the absence of such existing conductors, the systems illustrated by FIGS. 17 and 18 will perform as true through-the-earth systems. However, it should generally be expected that such existing conductors in the vicinity of antennae 190 and 200, while not necessary, will enhance the propagation of signals throughout the seam. It may be the case that the coupling of approximately linear antennas such as dipoles, and also all kinds of electric antennas, when positioned so that their principle current flow are parallel to incidental conductors within a mine, such as beltways and power lines, provide enhanced coupling to said incidental conductors when compared with magnetic loop antennas used for this purpose in the prior art.

In various configurations of yagi antennas, the reflector element may be replaced by a director element of length smaller than that of the driven element which is placed forward of the driven element in the desired direction of radiation. Also, it will be obvious that in all the above configurations of yagi antennas, additional forward gain and stronger signals in the desired direction can be obtained by adding additional director elements to a reflector element and a driven element.

### Transforming Input Impedances of Radiating Antennas

As mentioned previously herein, in order to efficiently transfer power into a radiating antenna, transformation of the antenna's input impedance to match the value of the output of the transmitter may be performed. This may be accomplished by making the radiating antenna resonant though the methods described above, so that it inherently matches the impedance of the transmitter and transmission line to be used. This is generally because losses in an external impedance matching device and the transmission line connecting it to the antenna are typically greater than those which would occur in techniques involving modification of the antenna itself, such as those comprised of adding loading coils or capacitors to the antenna itself to achieve resonance. Such loading elements in the antenna can be large, efficient, and actually make up part of the radiating elements of the antenna. Further, those loading devices within the antenna itself can be relatively fixed once the antenna is set up, whereas an external impedance matching device may need to be inherently adjustable, and such adjustability requires the use of components and circuits which may be much more likely to induce losses in the system.

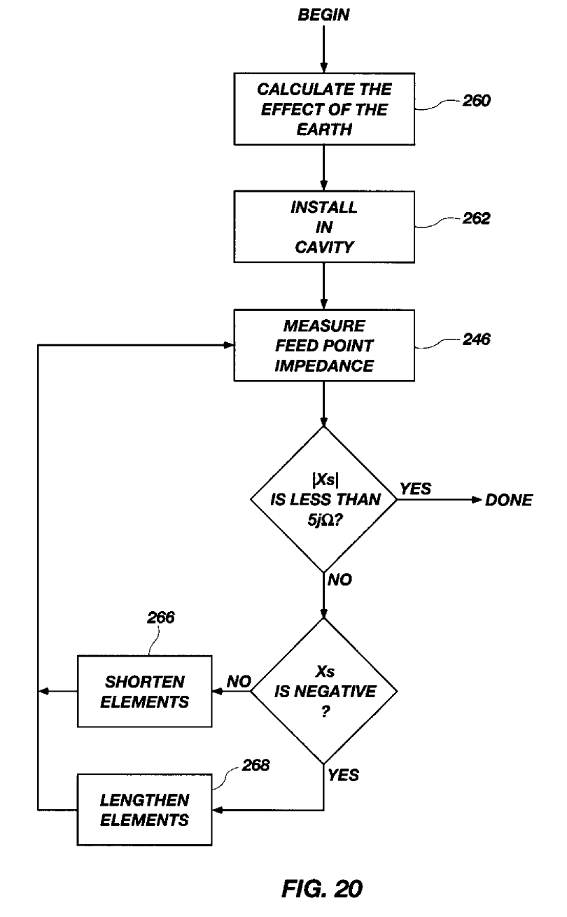

One method of resonating an underground full length dipole such as belowground antenna 70 of FIG. 1 is illustrated in FIG. 20. In process 260, the initial length of the dipole elements is calculated by the formula K=1−0.7/D², where K is the factor by which lengths of dipole elements cavity are to be reduced from their freespace values, and D is the mean diameter of the cavity in meters, for values of D where D>2. Process 261 involves preparing conducting elements 76a and 76b by cutting them approximately to their freespace resonant lengths using standard formulas. Process 262 involves installing said elements in the desired position within the underground cavity 80. When the belowground system 20 is being designed, the exact characteristics of the antennas may vary in every location due to unknown and uncontrollable elements of their environments. This is especially true with respect to shortened radiating antennas. It is therefore advisable that the antenna be positioned in its actual operating location before final adjustments for resonance are made. In step 264 and impedance measuring device such as the AIM4170C Antenna Analyzer manufactured by Array Solutions is temporarily connected to RF connector 84a and the impedance at the desired frequency is measured. If the absolute value of the series reactance, |Xs|, is less than some acceptable value, for example, 5j ohms, then the antenna is considered to be resonant and the entire process is complete. Otherwise, if said Xs is negative, the process 266 is performed wherein conducting elements 76a and 76b are lengthened a small amount, following which process 264 is repeated, and if said Xs is positive process 268 is performed wherein said elements are cut a small amount following which process 264 is repeated. If the desired minimum value of reactance is not achieved, the entire process is terminated when the lowest possible value of said |Xs| is achieved.

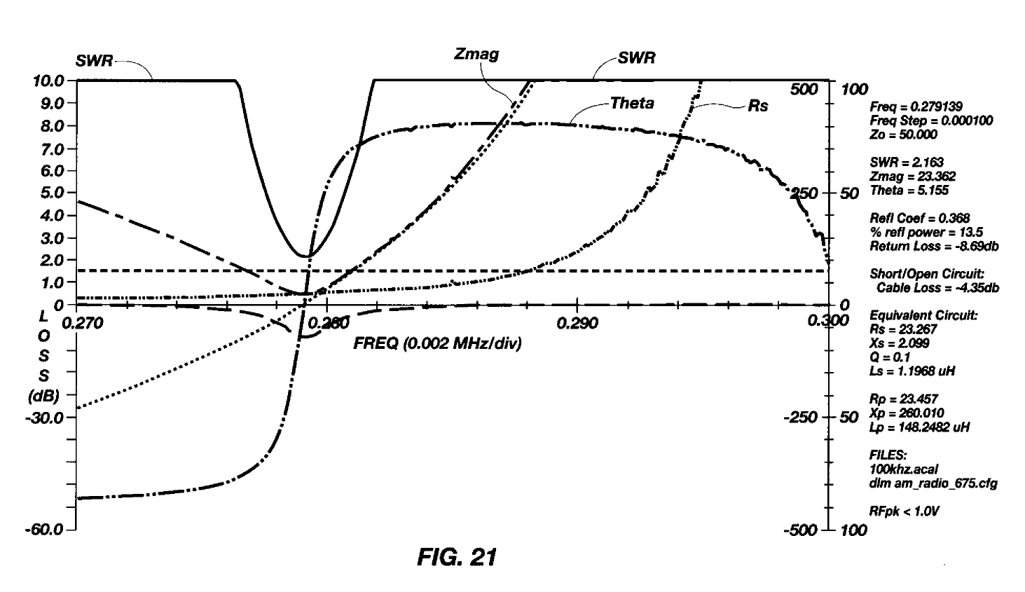

FIG. 21 shows the result of the measurement of step 264, as shown on the screen of the AIM4170C Antenna Analyzer. The point of resonance is indicated by the lowest point of the SWR line. Since the impedance has a positive reactive component, it is necessary to lengthen the dipole elements in this example to achieve exact resonance.

In another embodiment, processes 266 and 268 are performed by decreasing and increasing, respectively, the inductance of the inductive loading coils of an inductively loaded dipole antenna, for example, loading coils 142a and 142b of FIG. 13.

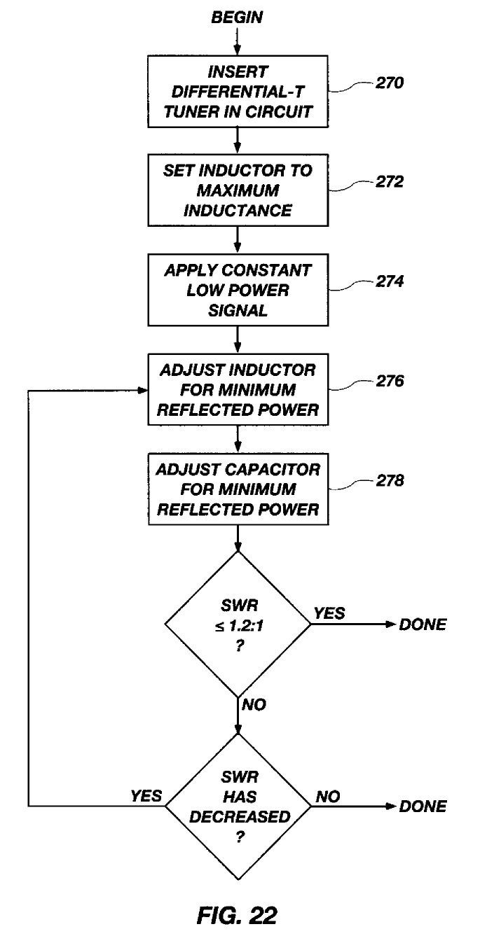

To the extent that resonating the antenna itself is not fully possible, or in cases where resonance of the antenna is achieved but the antenna still presents a low radiation resistance Rs, an impedance matching device external to the antenna may be employed as depicted by antenna impedance matching device 86 in FIG. 1. The process of using said impedance matching device 86 to raise the antenna radiation resistance to a level suitable for matching the output impedance of transceiver 92, and to cancel any remaining reactance in the antenna, is depicted by the flowchart in FIG. 22. This process should be completed after that of FIG. 20. In the first step 270, an impedance matching device 86, such as the MFJ-986 Differential T Antenna Tuner is inserted in the circuit as shown in FIG. 1. As shown in process 272, the inductance of said matching device 86 is set to a maximum value. This is because in cases where there are multiple possible values for matching the antenna, the preferred value will usually have the greatest inductance and the least capacitance. In the next step 274, a low amount of power is transmitted from transceiver 92 at the desired frequency. Following this, process 276 is performed wherein the inductance of matching device 86 is lowered until a local minimum of reflected power is indicated on the meter of matching device 86. Then, the capacitance of matching device 86 is adjusted back and forth until the lowest reflected power level is achieved. At this point if the VSWR is close to 1:1, then a good match has been achieved and the entire process is considered done. Otherwise, if the VSWR has not gone down since the previous best value, then the best possible match is considered to have been achieved and the entire process is done. If the VSWR has decreased, then processes 276 and 278 are repeated until a best possible match is achieved.

Periodically, processes 276 and 278 are to be repeated, especially during operation of transceiver 92. Small changes in the antenna components or in the antenna's environment may detune it. This may be particularly true with an antenna in an underground cavity, and also with any substantially shortened antennas above or belowground. In these situations, the antennas used may have a lower bandwidth and a higher Q factor than other kinds of antennas and must be critically tuned. Even more so, HF or MF antennas that are part of a portable or handheld radio device aboveground and especially underground will be subject to said detuning with the slightest changes around them, because their very short antennas will tend to be critically tuned and because they will be subject to changes due to the proximity of the person using the device, the motion of objects around the antenna, and the person's motion.

Therefore, in one embodiment of the invention an automatic impedance matching device may be employed. The device must be designed and constructed so as to respond quickly to all sorts of environmental changes to maintain a good impedance match and make the operation of the systems utilized in through-the-earth communications more effective and convenient. This is especially the case with systems that are to be used in a mobile manner such as handheld system 120 in FIG. 5 and any that are to be used by personnel who are not expected to have extensive training to operate said systems.

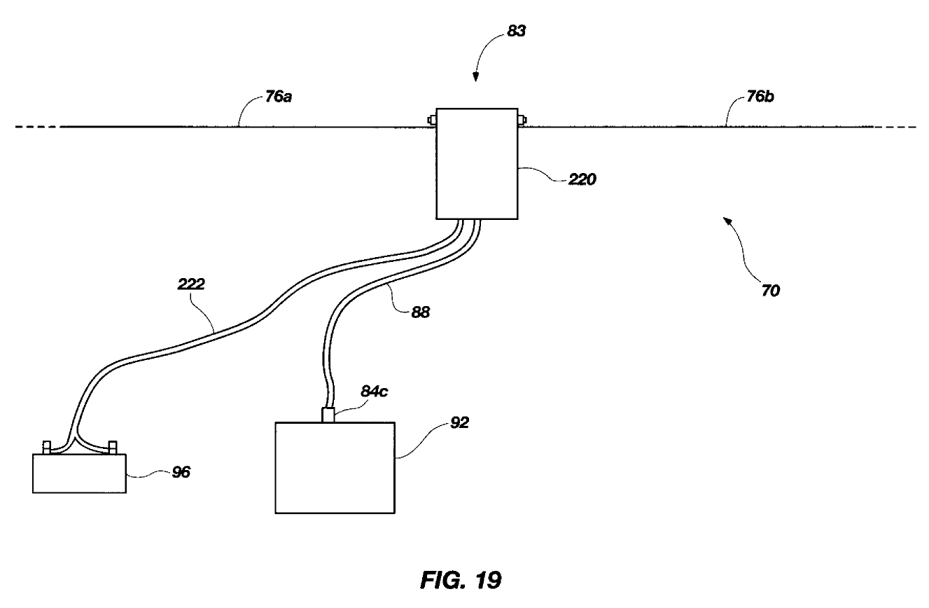

Referring again to FIG. 1, such impedance matching devices are used and designated therein as devices 56 and 86 which are connected between the radiating antennas 40 and 70 and transceivers 58 and 92. In addition to the antenna impendence matching devices such as 56 and 86, which are also commonly referred to as “antenna tuners,” another type exists which may be inserted at the feed point of the antenna. This type is sometimes referred to as an “antenna coupling” device. This kind of device has the advantage of eliminating the coaxial cables 52 and 78. Such a configuration is shown in FIG. 19 wherein the antenna 70 of FIG. 1 may be slightly modified fed by the replacement of insulating strain reliever 82 that may be replaced by antenna coupling device 220 at a dipole antenna's feed point 83. An antenna coupling device 220 may be connected to conducting elements 76a and 76b. Coaxial cable 88, may connect antenna coupling device 220 to the transceiver 92. Power may be supplied to antenna coupling device 220 by power cable 222 from power supply 96.

In one embodiment, antenna coupling device 220 is a commercially available coupling device called the SG-235 manufactured by SGC of Bellevue, Wash. Internally this device may include a circuit with many capacitors and inductors which are switched in and out of the circuit to obtain a combination which gives a good impedance match. The SG-235 is convenient to use because it automatically senses the frequency of transmission and automatically retunes whenever needed.

An automated antenna coupling device like the SG-231 may be convenient to use, but it may not the most efficient device for use in resonating the antenna at the feed point, especially when low impedance, shortened antennas are used. In other embodiments other types of more efficient coupling devices are used which include coils, capacitors, RF transformers, baluns, transmission line stubs, and other elements which can be configured to compensate for the low impedance at the feed point of the antenna. Coupling devices may utilize a few very low loss components and will not necessarily use switching between components, which may otherwise introduce losses.

In another embodiment, the transceiver 92 is custom designed to produce and receive RF energy at extremely low impedances and provide a good impendence match to the antenna 70 with less or no need for an external impedance matching device, such as 86 or 220. In a further embodiment, the transceiver 92 may be inserted at antenna 70's feed point 83 and connected directly to conducting elements 76a and 76b, eliminating the need for a coaxial cable 88. In these embodiments, the transceiver RF circuits, may be constructed as an integral part of the antenna system, and may be designed to handle the high current and low impedance that will be present at the feed point 83 of antenna 70 when it is shortened.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed:

1. A wireless, through-the-earth communication system, comprising:
an earth formation;
a first communication element in the earth formation, the first communication element including: a transmitter;
a radiating antenna in communication with the transmitter for generating and transmitting electromagnetic waves of the predetermined carrier frequency; and
a second communication element configured to communicate through the earth formation with the first communication element at the predetermined carrier frequency, the second communication element including:
an antenna for receiving electromagnetic waves of the predetermined carrier frequency; and
a receiver in communication with the antenna.

2. The wireless, through-the-earth communication system of claim 1, wherein the first communication element further includes:
a receiver in communication with the radiating antenna of the first communication element.

3. The wireless, through-the-earth communication system of claim 2, wherein the transmitter and the receiver of the first communication element are combined.

4. The wireless, through-the-earth communication system of claim 2, wherein the second communication element further includes:
a transmitter in communication with the antenna of the second communication element.

5. The wireless, through-the-earth communication system of claim 4, wherein the receiver and the transmitter of the second communication element are combined.

6. The wireless, through-the-earth communication system of claim 1, wherein the second communication element is above ground.

7. The wireless, through-the-earth communication system of claim 1, wherein the second communication element is below ground.

8. The wireless, through-the-earth communication system of claim 1, wherein the first communication element and the second communication element are configured to communicate electromagnetic waves of a frequency of less than about 140 MHz.

9. The wireless, through-the-earth communication system of claim 8, wherein the first communication element and the second communication element are configured to communicate electromagnetic waves of a frequency of less than about 1.8 MHz.

10. The wireless, through-the-earth communication system of claim 9, wherein the first communication element and the second communication element are configured to communicate electromagnetic waves of a frequency in a range of about 100 kHz to about 1 MHz.

11. The wireless, through-the-earth communication system of claim 1, wherein the first communication element and the second communication element communicate a minimum distance of about 100 feet through the earth formation.

12. The wireless, through-the-earth communication system of claim 11, wherein the first communication element and the second communication element communicate a minimum distance of about 300 feet through the earth formation.

13. The wireless, through-the-earth communication system of claim 1, wherein at least one of the first communication element and the second communication element includes an impedance matching device.

14. The wireless, through-the-earth communication system of claim 13, wherein at least one circuit element of the impedance matching device is cooled to a state of enhanced electrical conductivity.

15. The wireless, through-the-earth communication system of claim 14, wherein the at least one circuit element of the impedance matching device is cooled to a state of superconductivity.

16. The wireless, through-the-earth communication system of claim 1, wherein at least the first communication element includes a high temperature superconductor material.

17. The wireless, through-the-earth communication system of claim 16, wherein the high temperature superconductor material enhances a state of electrical conductivity of at least a portion of the radiating antenna.

18. The wireless, through-the-earth communication system of claim 1, wherein the radiating antenna of the first communication element includes:
a feed point;
a first antenna element in electrical communication with the feed point so as to receive power from the feed point; and
a second antenna element in electrical communication with the feed point so as to receive power from the feed point, the second antenna element arranged relative to the first antenna element such that an alternating voltage of the predetermined carrier frequency at the feed point will generate an alternating electric field between the first antenna element and the second antenna element,
at least one of the first and second antenna elements being electrically isolated from the earth formation.

19. The wireless, through-the-earth communication system of claim 18, wherein both the first antenna element and the second antennal element are electrically isolated from the earth formation.

20. The wireless, through-the-earth communication system of claim 18, wherein the first antennal element and the second antenna element are electrically isolated from one another.

21. The wireless, through-the-earth communication system of claim 18, wherein the radiating antenna of at least one of the first communication element and the second communication element further includes:
a third antenna element connecting ends of the first and second antenna elements.

22. The wireless, through-the-earth communication system of claim 1, wherein the radiating antenna includes at least one of a folded dipole antenna, an inverted V dipole antenna, a dipole antenna with a parasitic element, a dipole array antenna with multiple driven elements, a moxon dipole antenna, a large loop antenna, a quad antenna, a delta antenna, a long wire antenna, a rhombic antenna, a beverage antenna, a monopole antenna, a whip antenna, a bowtie antenna, a Goubau antenna, a normal mode helical dipole antenna, an L antenna, and an off-center-fed dipole antenna.

23. The wireless, through-the-earth communication system of claim 1, wherein the radiating antenna of at least one of the first and second communication elements comprises at least a part of a resonant antenna system.

24. The wireless, through-the-earth communication system of claim 1, wherein the radiating antenna of at least one of the first and second communication elements comprises at least one of an inductively loaded radiating antenna, a capacitively loaded radiating antenna, a linear loaded radiating antenna, and a meander line antenna.

25. The wireless, through-the-earth communication system of claim 1, wherein a greatest extent of an electric field generated by the radiating antenna of at least the first communication element is at least one thousandth of a length of a freespace wavelength of the electromagnetic waves of the predetermined carrier frequency.

26. The wireless, through-the-earth communication system of claim 25, wherein a greatest extent of an electric field generated by the radiating antenna of at least the first communication element is at least three hundredths of a length of a freespace wavelength of the electromagnetic waves of the predetermined carrier frequency.

27. The wireless, through-the-earth communication system of claim 26, wherein the greatest extent of the electric field generated by the radiating antenna of at least the first communication element is at least one hundredth of the length of the freespace wavelength of the electromagnetic waves of the predetermined carrier frequency.

28. The wireless, through-the-earth communication system of claim 27, wherein the greatest extent of the electric field generated by the radiating antenna of at least the first communication element is at least one tenth of the length of the freespace wavelength of the electromagnetic waves of the predetermined carrier frequency.

29. The wireless, through-the-earth communication system of claim 26, wherein the greatest extent of the electric field generated by the radiating antenna comprises a greatest distance across the radiating antenna of at least the first communication element.

30. The wireless, through-the-earth communication system of claim 1, wherein at least the first communication element is configured to prevent fire or explosion in a mine environment.

31. The wireless, through-the-earth communication system of claim 1, further comprising at least one of:
an underground personnel locating system; and
an underground personnel communication system.

32. The wireless, through-the-earth communication system of claim 31, wherein the underground personnel locating system employs radiofrequency identification devices.

33. The wireless, through-the-earth communication system of claim 1, wherein the radiating antenna of the first communication element is oriented substantially horizontally.

34. A wireless, through-the-earth communication system, comprising:
an earth formation;
a first communication element, including:
a transmitter;
a radiating antenna in communication with the transmitter for generating electromagnetic waves of a predetermined carrier frequency; and
a second communication element in the earth formation, the second communication element including:
a radiating antenna for receiving electromagnetic waves of the predetermined carrier frequency transmitted through the earth formation; and
a receiver in communication with the radiating antenna.

35. A method for establishing an underground wireless communication point, comprising:
placing a first antenna element of a radiating antenna in a cavity of an earth formation and in electrical isolation from the earth formation with the first element extending in a first direction;
placing a second antenna element of the radiating antenna within the cavity of the earth formation with the second element extending in a second direction; and
establishing communication between the radiating antenna and a transmitter.

36. The method of claim 35, wherein placing the second antenna element comprises electrically isolating the second antenna element from the earth formation.

37. The method of claim 35, wherein placing the second antenna element comprises orienting the second antenna element in the second direction at an angle of at least about 45° to the first direction of the first antenna element.

38. The method of claim 35, wherein placing the first antenna element and placing the second antenna element comprise placing the first and second antenna elements within a mine.

39. The method of claim 35, further comprising:
tuning the radiating antenna to transmit electromagnetic radiation through the earth formation at a predetermined carrier frequency to compensate for electric effects of the earth formation.

40. The method of claim 39, wherein tuning comprises adjusting an electrical length of the radiating antenna.

41. A method for tuning a radiating antenna for communication at a predetermined carrier frequency through an earth formation, comprising:
providing a radiating antenna with a reduced length relative to a resonant length for the radiating antenna at a predetermined carrier frequency above ground at an underground location;
reducing an electrical length of the radiating antenna relative to a known above-ground resonant length when the radiating antenna is used at the predetermined carrier frequency; and
adjusting the electrical length of the radiating antenna, the electrical length remaining less than the known above-ground resonant length to achieve a desired impedance match at a feed point of the radiating antenna.

42. The method of claim 41, wherein adjusting the electrical length includes compensating for electric effects of the earth formation on at least a portion of the radiating antenna.

43. The method of claim 41, wherein adjusting the electrical length further includes coupling at least the portion of the radiating antenna to at least one incidental conductor in the earth formation.

44. The method of claim 42, wherein adjusting the electrical length of the radiating antennal comprises connecting an impedance matching device to the feed point of the radiating antenna to transform impedance between an input of the impedance matching device and the feed point of the radiating antenna.

45. The method of claim 44, wherein adjusting comprising adding to series inductive reactance to the radiating antenna as the radiating antenna is fed at the input of the impedance matching device.

46. The method of claim 41, wherein adjusting is automatically effected.

47. The method of claim 41, wherein adjusting is manually effected.

48. The method of claim 41, wherein adjusting the electrical length includes:
measuring at least one characteristic of the radiating antenna;
adjusting the electrical length; and
remeasuring the at least one characteristic.

49. The method of claim 48, wherein measuring the at least one characteristic of the radiating antenna includes at least one of:
measuring impedance at the feed point;
using a network analyzer;
measuring a standing wave ratio; and
measuring power transfer into the radiating antenna.

50. The method of claim 48, wherein adjusting the electrical length further includes:
repeating the adjusting and the remeasuring until the desired impedance is achieved.

51. The method of claim 41, wherein adjusting the electrical length comprises at least one of:
reducing or increasing a physical length of at least one conductive element of the radiating antenna;
adjusting an inductance of at least one inductive element of the radiating antenna;
adjusting a capacitance of at least one conductive element of the radiating antenna;
changing a location of the feed point of the radiating antenna; and
selecting a setting of an impedance matching device associated with the radiating antenna.

52. A method for communicating through an earth formation, comprising transmitting electromagnetic waves of a predetermined carrier frequency through an earth formation from a first radiating antenna at a first location on one side of the earth formation to a second radiating antenna at a second location on an opposite side of the earth formation.

53. The method of claim 52, wherein transmitting comprises transmitting the electromagnetic waves through at least 100 feet of the earth formation.

54. The method of claim 53, wherein transmitting comprises transmitting the electromagnetic waves through at least 300 feet of the earth formation.

55. The method of claim 52, wherein transmitting comprises transmitting the electromagnetic waves at a predetermined carrier frequency of about 140 MHz or less.

56. The method of claim 55, wherein transmitting comprises transmitting the electromagnetic waves at a predetermined carrier frequency of about 1.8 MHz or less.

57. The method of claim 56, wherein transmitting comprises transmitting the electromagnetic waves at a predetermined carrier frequency in a range of about 100 kHz to about 1 MHz.

58. The method of claim 52, wherein transmitting comprises transmitting electromagnetic waves from an underground location.

59. The method of claim 58, wherein transmitting comprises transmitting electromagnetic waves to another underground location.

60. The method of claim 58, wherein transmitting comprises transmitting electromagnetic waves to an above ground location.

61. The method of claim 52, wherein transmitting comprises transmitting electromagnetic waves to an underground location.

62. A superconductive radiating antenna, comprising:
a radiating antenna;
at least one of superconductive coils and superconductive capacitor elements for inductively loading elements of the radiating antenna;
a hermetically sealed cooling chamber surrounding at least the superconductive coils; and
a cryogenic cooling device in communication with interior chambers within the hermetically sealed cooling chamber.
